(19) United States
(12) Patent Application Publication
(10) Pub. No.: US 2016/0260116 A1
(43) Pub. Date: Sep. 8, 2016

(54) UNIVERSAL REWARDS MANAGEMENT

(71) Applicants: Xi Xie, Sunnyvale, CA (US); Liyu Yi, Fremont, CA (US)

(72) Inventors: Xi Xie, Sunnyvale, CA (US); Liyu Yi, Fremont, CA (US)

(21) Appl. No.: 14/637,031

(22) Filed: Mar. 3, 2015

(51) Int. Cl. G06Q 30/02

(52) U.S. Cl. CPC G06Q 30/0227; G06Q 30/0233

(57) ABSTRACT

A computer implemented method and a universal rewards management system (URMS) are provided for managing collection and redemption of universal rewards. The URMS establishes a communication between a consumer device and a merchant device via a network and communicates purchase transaction information of a consumer's purchase to the merchant device for acquiring a reward generation approval from the merchant device. The URMS generates universal reward points redeemable for any reward voucher issued by any merchant, using the purchase transaction information and predetermined computation parameters based on the acquired reward generation approval. The URMS generates a reward voucher redeemable from the merchant associated with the purchase, for a subsequent purchase made by any consumer using other predetermined computation parameters. The URMS communicates a reward voucher redemption request to the merchant device for acquiring a reward voucher redemption approval. If approved, the URMS determines a reduced cost for the subsequent purchase.

### CROSS-REFERENCE TO RELATED APPLICATIONS

This application claims priority to and the benefit of provisional patent application No. 61/947,429 titled “A Universal Rewards and Vouchers Program”, filed in the United States Patent and Trademark Office on Mar. 4, 2014. The specification of the above referenced patent application is incorporated herein by reference in its entirety.

### BACKGROUND

Loyalty programs are structured marketing strategies adopted by merchants for rewarding their customers, herein referred to as “consumers”, for purchasing products and/or services from the merchants, for ensuring consumer retention, and for increasing consumer satisfaction, thereby increasing revenue generation and profitability. Merchants adopt loyalty programs to attract a wide range of consumers and encourage consumer loyalty by providing the consumers, for example, with vouchers, coupons, tokens, etc., that are redeemable at merchant stores. Conventional loyalty programs reward consumers, for example, with loyalty cards, reward points, club cards, vouchers, etc. Consumers can redeem these rewards, for example, for purchasing products and/or services at discounted rates, for purchasing gift cards, for availing cash back offers, etc., at merchant stores.

Typically, merchants provide rewards in the form of cards or coupons. However, it is difficult for consumers who are enrolled with multiple loyalty programs of multiple merchants to carry around multiple gift cards, vouchers, coupons, etc. Moreover, due to the availability of a large number of vouchers to the consumers from a large number of merchants, consumers may lose their vouchers, thereby adversely affecting the merchants' businesses. Furthermore, the conventional approach of loyalty programs encourages consumers to visit only the same merchant store that provides the rewards, thereby limiting the consumers' shopping experience and making the consumers' shopping experience monotonous and lacking in variety. Conventional rewards or coupons are typically limited to the same merchant store. Moreover, the typical rewards or coupons are redeemable only on a limited number of products and/or services. Hence, the typical rewards along with their purchasing restrictions are not successful in attracting more consumers or bringing back old consumers to a merchant store.

Furthermore, conventional voucher management systems are not time efficient in managing redemption of rewards. Conventional paper forms of rewards cannot be redeemed in real time. Typically, by the time the consumer wants to use a voucher received from a merchant at a desired merchant store, the desired product at the merchant store is out of stock or the voucher may have expired. Hence, this approach is not effective for obtaining discounts on high demand products or products that have short selling periods. Moreover, if consumers do not make sufficient purchases at a particular merchant store, they are less likely to enroll in the merchant's loyalty program. Typical loyalty programs may require that earned rewards are redeemed at a single merchant or a limited group of merchants, thereby limiting the choice of products and/or services or locations of merchant stores available to the consumer. Such restrictions inconvenience to consumers and further discourage them from participating in the merchants' loyalty programs.

Furthermore, conventional voucher management systems typically provide a list of merchants already registered with the voucher management systems, from which consumers can select a merchant for purchasing products and/or services. Typically, these voucher management systems do not allow consumers to invite merchants into a network of merchants who are registered with the voucher management systems. There is a need for allowing consumers to invite merchants for registration into the network to allow consumers to select merchants of their choice in the network, purchase products and/or services from the selected merchants, and avail discounts or other benefits of the selected merchants' loyalty programs.

Hence, there is a long felt but unresolved need for a computer implemented method and system that time effectively manages collection and redemption of universal rewards. Moreover, there is a need for a computer implemented method and system that allows merchants to provide digital and universal reward points to their consumers, where the universal reward points are maintained in an electronic account and are redeemable for any reward voucher issued by any merchant for multiple different products and/or services at the merchant store. Furthermore, there is a need for a computer implemented method and system that creates a network where the universal reward points are shared and exchanged among the consumers, and that maintains an accounting system where total redeemable universal reward points are equal to reward vouchers offered by all the merchants in the network in total. Furthermore, there is a need for a computer implemented method and system that allows consumers to select merchants of their choice for availing discounts or other benefits offered by the selected merchants' loyalty programs and inviting the selected merchants to join a network of registered merchants.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The computer implemented method and system disclosed herein addresses the above stated needs for time effectively managing collection and redemption of universal rewards. Moreover, the computer implemented method and system disclosed herein allows merchants to provide digital and universal reward points to their consumers, where the universal reward points are maintained in an electronic account and are redeemable for any reward voucher issued by any merchant for multiple different products and/or services at a merchant store. Furthermore, the computer implemented method and system disclosed herein creates a network where the universal reward points are shared and exchanged among the consumers, and maintains an accounting system where total redeemable universal reward points are equal to reward vouchers offered by all the merchants in the network in total. Furthermore, the computer implemented method and system disclosed herein allows consumers to select merchants of their choice for availing discounts or other benefits offered by the selected merchants' loyalty programs and inviting the selected merchants to join a network of registered merchants.

The computer implemented method disclosed herein employs a universal rewards management system comprising at least one processor configured to execute computer program instructions for managing collection and redemption of universal rewards. The universal rewards management system establishes a communication between a consumer device and a merchant device based on communication criteria, on receiving a communication request from each of the consumer device and the merchant device via a network. The universal rewards management system communicates purchase transaction information associated with a purchase made by a consumer, received from the consumer device to the merchant device via the network, for acquiring a reward generation approval from the merchant device. The universal rewards management system generates universal reward points for the purchase made by the consumer using the purchase transaction information and one or more of multiple predetermined computation parameters based on the reward generation approval acquired from the merchant device. The generated universal reward points are redeemable for any reward voucher issued by any merchant.

The universal rewards management system generates a reward voucher redeemable from the merchant associated with the purchase, for a subsequent purchase made by the consumer who made the purchase or any other consumer using another one or more of the predetermined computation parameters. The universal rewards management system communicates a reward voucher redemption request for redeeming the generated reward voucher from the consumer device of the consumer who made the purchase or another consumer to the merchant device via the network, for acquiring a reward voucher redemption approval from the merchant device. The universal rewards management system determines a reduced cost for the subsequent purchase made by the consumer who made the purchase or another consumer based on the acquired reward voucher redemption approval to the reward voucher redemption request.

In one or more embodiments, related systems include but are not limited to circuitry and/or programming for effecting the methods referenced herein; the circuitry and/or programming can be any combination of hardware, software, and/or firmware configured to effect the herein-referenced methods depending upon the design choices of a system designer. Also, various structural elements may be employed depending on the design choices of the system designer.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and components disclosed herein. The description of a method step or a component referenced by a numeral in a drawing carries over to the description of that method step or component shown by that same numeral in any subsequent drawing herein.

FIG. 1 illustrates a computer implemented method for managing collection and redemption of universal rewards.

FIG. 2 exemplarily illustrates a flowchart comprising the steps for collecting universal reward points by a consumer.

FIG. 3 exemplarily illustrates a flowchart comprising the steps for redeeming a reward voucher at a merchant location.

FIG. 4A exemplarily illustrates a computer implemented system showing communication between a universal rewards management system, a consumer device, and a merchant device for managing collection and redemption of universal rewards.

FIG. 4B exemplarily illustrates the computer implemented system for managing collection and redemption of universal rewards.

FIG. 5 exemplarily illustrates the hardware architecture of the universal rewards management system employed for managing collection and redemption of universal rewards.

FIGS. 6-45 exemplarily illustrate screenshots of graphical user interfaces (GUIs) provided by the universal rewards management system for managing collection and redemption of universal rewards.

### DETAILED DESCRIPTION OF THE INVENTION

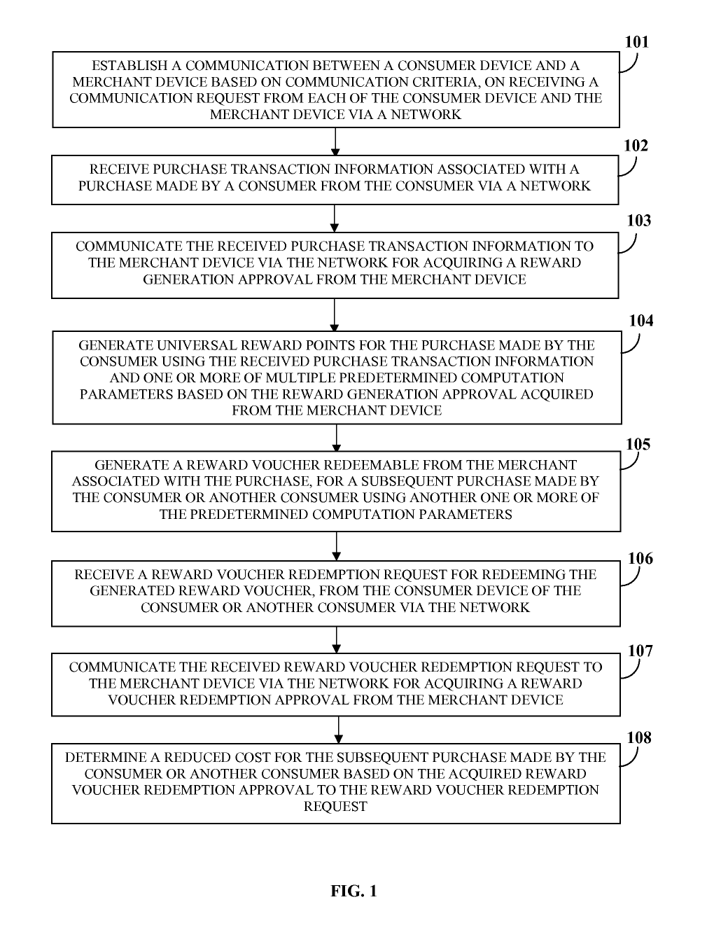

FIG. 1 illustrates a computer implemented method for managing collection and redemption of universal rewards. As used herein, “universal rewards” refers to items of value, for example, virtual reward points, virtual currencies, etc., that can be allocated and converted into real or virtual reward points, currency, cash of value, etc., and redeemed for reward vouchers issued by multiple different merchants. The rewards comprise, for example, reward points, reward points redeemable for cash, reward points redeemable for reward vouchers, scores, scores redeemable for cash, scores redeemable for reward vouchers, cash, units of virtual currency, and other items of value. As used herein, “reward voucher” refers to a digitized reward card that awards a consumer with discounts in purchases of products and/or services from a merchant who issued the reward voucher. The computer implemented method disclosed herein employs a universal rewards management system comprising at least one processor configured to execute computer program instructions for managing collection and redemption of universal rewards. The computer implemented method and the universal rewards management system disclosed herein implement a universal reward points and reward vouchers management program. The universal rewards management system computes and awards universal reward points to participating consumers registered with the universal rewards management system, issues reward vouchers to the consumers upon redemption of the universal reward points generated by the universal rewards management system, and maintains necessary accounting of balances as consumers use their reward vouchers at participating merchants for a purchase.

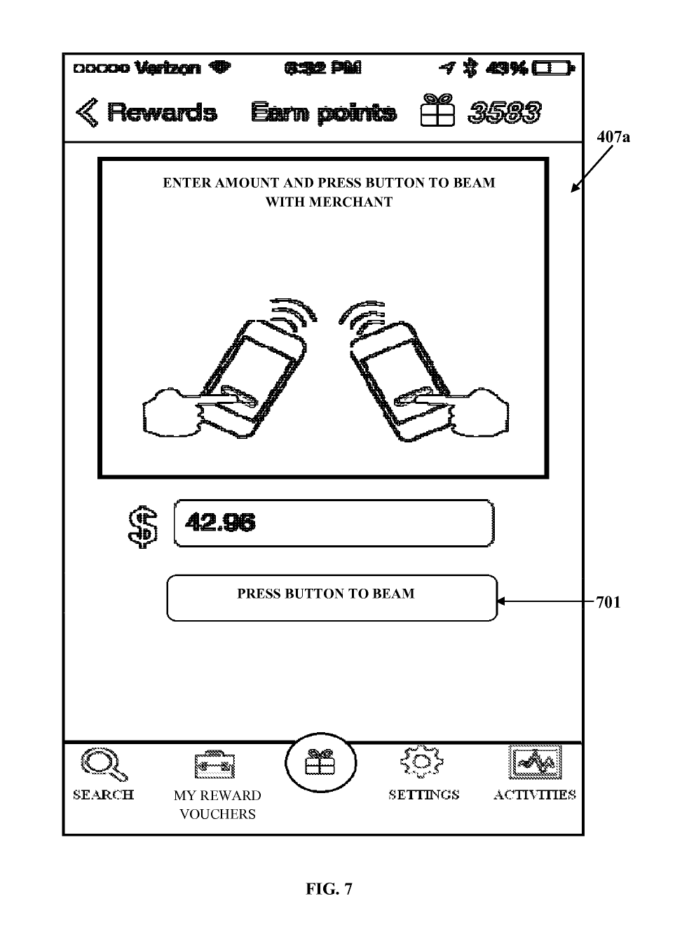

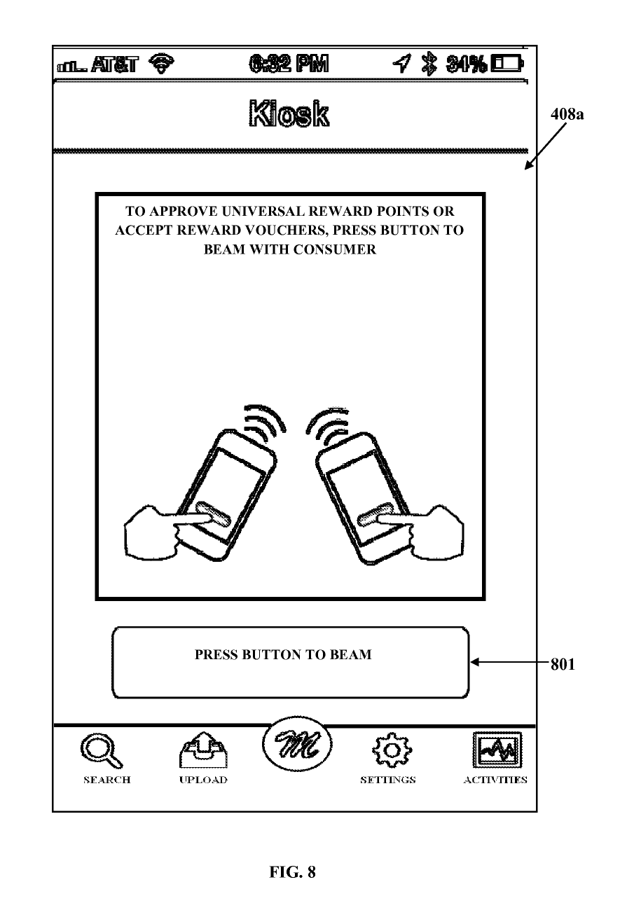

The universal rewards management system comprises a rewards management application. In an embodiment, the rewards management application is implemented as a consumer rewards management application installable on a consumer device used by a consumer, and a merchant rewards management application installable on a merchant device used by a merchant. The universal rewards management system establishes 101 a communication between a consumer device and a merchant device based on communication criteria, on receiving a communication request from each of the consumer device and the merchant device via a network. The consumer rewards management application and the merchant rewards management application send communication requests to a communication server of the universal rewards management system to establish a communication channel with the communication server. The communication requests comprise multiple parameters, for example, a timestamp, geographical coordinates such as latitudinal and longitudinal information of each of the consumer device and the merchant device, a network address of each of the consumer device and the merchant device, etc., or any combination thereof. The universal rewards management system transmits corresponding communication channel identifiers (IDs) to the consumer device and the merchant device. In an embodiment, the consumer device and the merchant device transmit the communication requests to the universal rewards management system, for example, by clicking on a “beam” interface element exemplarily illustrated in FIGS. 7-8, provided on graphical user interfaces (GUIs) of the consumer rewards management application and the merchant rewards management application respectively, or by any method that triggers the consumer device and the merchant device to perform functions simultaneously, for example, by physically shaking the consumer device and the merchant device, which allows a handshake between the consumer device and the merchant device.

The communication criteria for establishing the communication comprise, for example, a time difference between each communication request from each of the consumer device and the merchant device, a geographical distance between the consumer device and the merchant device, verification of the network address of each of the consumer device and the merchant device, etc., or any combination thereof. In an example, the universal rewards management system establishes communication between the consumer device and the merchant device based on a time difference of about 3 seconds between the communication requests from the consumer device and the merchant device, a geographical distance of about 50 meters (m) between the consumer device and the merchant device determined, for example, using latitudinal and/or longitudinal information of the consumer device and the merchant device, etc. The universal rewards management system transmits the communication channel IDs to the consumer device and the merchant device via a network, as a result of the pairing between the consumer device and the merchant device. The consumer device receives the communication channel ID of its peer merchant device from the universal rewards management system. The merchant device receives the communication channel ID of its peer consumer device from the universal rewards management system.

The universal rewards management system receives 102 purchase transaction information associated with a purchase made by a consumer from the consumer device via the network. As used herein, “purchase transaction information” refers to information associated with a purchase of a product and/or a service made by a consumer at a merchant location, which is used to compute universal reward points redeemable by the consumer for a subsequent purchase at the same or different merchant location. The purchase transaction information comprises, for example, an amount of a purchase transaction calculated in dollars, an amount of a purchase transaction substantially below an amount paid by a consumer when a merchant deems only part of the purchase transaction eligible for generating universal reward points, an amount of a purchase transaction substantially above an amount paid by a consumer when a merchant is implementing a multiplied rewards program or when a merchant is willing to count one or more prior purchase transactions with the consumer which are not yet recorded by the universal rewards management system for generating universal reward points and reward vouchers redeemable from the merchant, etc.

The universal rewards management system communicates 103 the received purchase transaction information to the merchant device via the network for acquiring a reward generation approval from the merchant device. The universal rewards management system receives an authenticated “earn reward point” transaction request from the consumer device. The universal rewards management system generates a transaction identifier (ID) associated with the received authenticated “earn reward point” transaction request and transmits the generated transaction ID to the consumer device. The consumer device transmits the purchase transaction information comprising, for example, the type of communication such as a communication to earn universal reward points, the transaction ID, an amount associated with a purchase transaction, a consumer ID, name of a consumer, etc., to the merchant device via the universal rewards management system over the network.

When a participating consumer makes a purchase of a product and/or a service at a participating merchant location, the consumer utilizes the consumer rewards management application installed on the consumer device and the merchant utilizes the merchant rewards management application installed on the merchant device to notify the universal rewards management system of a transaction amount paid by the consumer to the merchant for the purchased products or services. The amount communicated to the universal rewards management system is agreed upon by the consumer and the merchant at the time of purchase, and the universal rewards management system uses the purchase transaction amount to compute universal reward points corresponding to the purchase transaction.

The universal rewards management system generates 104 universal reward points for the purchase made by the consumer, using the received purchase transaction information and one or more of multiple predetermined computation parameters, based on the reward generation approval acquired from the merchant device. As used herein, “predetermined computation parameters” refer to parameters, for example, a reward point percentage (RPP), a voucher issuance amount threshold (VIAT), a voucher issuance percentage (VIP), etc., used for performing computations, for example, for computing the universal reward points, for determining a reward voucher amount owed by a merchant, for determining the number of reward vouchers issued by the merchant, etc. Also, as used herein, “reward point percentage” refers to a percentage of an amount paid by a consumer for a purchase of a product and/or a service, which is used as universal reward points for purchasing a reward voucher of any merchant. Also, as used herein, “voucher issuance amount threshold” (VIAT) refers to an amount of revenue generated by a merchant for generation of each reward voucher. Also, as used herein, “voucher issuance percentage” refers to a percentage of the VIAT to which a reward voucher amount is proportional. In an embodiment, the VIP is configured to be greater than or equal to the RRP. In an embodiment, the universal rewards management system configures the predetermined computation parameters based on merchant inputs received from the merchant device of each of the merchants. Each merchant configures values for the predetermined computation parameters using the merchant rewards management application on the merchant device and submits the values to the universal rewards management system. The generated universal reward points are redeemable for any reward voucher issued by any merchant.

Once the universal rewards management system receives the purchase transaction information comprising an amount of a purchase made by a consumer from the consumer device and approved by the merchant, along with one or more predetermined computation parameters, for example, the rewards point percentage, the universal rewards management system acknowledges the communication of the purchase transaction information and the predetermined computation parameters, for example, by transmitting a notification to the consumer device and the merchant device, and computes universal reward points for the purchase using the purchase transaction information and the predetermined computation parameters.

The universal rewards management system performs accounting of an amount of a purchase made by consumers, universal reward points, and values of reward vouchers. For every purchase made by a consumer, the universal rewards management system generates universal reward points for the consumer, based on one or more merchant-specific, predetermined computation parameters comprising, for example, a reward point percentage (RPP). In an example, the universal rewards management system generates universal reward points to be awarded to a consumer for a purchase using the following formula:

Universal reward points=Total purchase transaction amount*reward point percentage (RPP)

Using the above formula, if the RPP is set to 7% for a merchant, and the purchase transaction amount paid by a consumer to the merchant is $50, that is, 5000 cents, then the universal rewards management system generates 350 universal reward points for the consumer, by calculating 7% of 5000 cents.

The universal rewards management system maintains a consumer account for the consumer and credits the generated universal reward points to the consumer account. The consumer account is accessible by the consumer device for performing one or more actions, for example, acquire or redeem a reward voucher associated with the generated universal reward points. The universal rewards management system enables any consumer to acquire or redeem a reward voucher using the universal reward points from his/her consumer account. The universal reward points can be used to redeem any reward voucher from one of the multiple merchants in the network. In an embodiment, the universal rewards management system transmits a configurable amount of the generated universal reward points from the consumer account of the consumer who made the purchase to a consumer account of another consumer based on consumer sharing and exchange inputs received from the consumer device. As used herein, “consumer sharing and exchange inputs” refer to inputs provided by the consumer to the universal rewards management system for sharing and exchanging the generated universal reward points with other consumers in the network, according to preferences of the consumer. For example, if the consumer wants to share or exchange 10% of the generated 350 universal reward points in the consumer account with another consumer, the universal rewards management system transmits 35 universal reward points to the consumer account of the other consumer, by calculating 10% of the 350 universal reward points.

The universal rewards management system maintains a merchant account for each of the merchants registered with the universal rewards management system. In an embodiment, the universal rewards management system determines a redeemable reward voucher amount corresponding to the generated universal reward points using another one or more of the predetermined computation parameters, for example, the merchant-specific voucher issuance amount threshold (VIAT), the voucher issuance percentage (VIP), etc. In this embodiment, the universal rewards management system renders the determined redeemable reward voucher amount to the merchant account of the merchant associated with the purchase for generation of a reward voucher for a subsequent purchase made by the consumer who made the purchase and any other consumer with whom the universal reward points were shared or exchanged. The redeemable reward voucher of one merchant represents the merchant's commitment to honor the reward voucher at any point in the future when a participating consumer redeems his/her universal reward points for the reward voucher to be used at the merchant location when the consumer presents the reward voucher to the merchant. While the generated universal reward points are universal and can be used to purchase reward vouchers issued by multiple merchants, reward vouchers are merchant specific, that is, each reward voucher can only be redeemed from the merchant who issued the reward voucher. The consumer can earn universal reward points at one set of merchants and redeem them for reward vouchers issued by another set of merchants.

The universal rewards management system computes the redeemable reward voucher amount assigned to a merchant, for example, using the following formula:

Total redeemable reward voucher amount owed by a merchant=Total purchase transaction amount*voucher issuance percentage (VIP)

Consider an example where the total purchase transaction amount is $100 and the VIP is 10%. The universal rewards management system generates $10 as the total redeemable reward voucher amount owed by the merchant by calculating $100*10%. The universal rewards management system renders the determined redeemable reward voucher amount to the merchant account for generation of a reward voucher for a subsequent purchase made by the consumer who made the initial purchase or by another consumer.

The universal rewards management system determines a number of reward vouchers issued to each of the merchants using the received purchase transaction information and another one or more of the predetermined computation parameters, for example, the merchant-specific voucher issuance amount threshold (VIAT). The universal rewards management system computes the number of reward vouchers issued to the merchant, for example, using the following formula:

Number of issued reward vouchers=Modulus(Total purchase transaction amount/Voucher issuance amount threshold (VIAT))

Consider an example where the total purchase transaction amount is $500 and the VIAT is $100. The universal rewards management issues 5 reward vouchers to the merchant by calculating Modulus ($500/$100). The universal rewards management system determines the number of reward vouchers issued to provide each merchant with statistics and reports that include total revenue made by the merchant, number of reward vouchers that have been redeemed, number of reward vouchers that are outstanding or not redeemed, etc.

In an embodiment, the universal rewards management system generates supplementary universal reward points for the consumer on registration of one or more merchants invited by the consumer to the universal rewards management system. In an embodiment, the universal rewards management system determines the supplementary universal reward points based on revenue generated by the invited merchants. In another embodiment, the universal rewards management system allows consumers to design their own loyalty programs affiliated with one or more merchants who can then redeem reward vouchers that were purchased by the consumers using the universal reward points time effectively.

The universal rewards management system generates 105 a reward voucher redeemable from the merchant associated with the initial purchase, for a subsequent purchase made by the consumer who made the initial purchase or any consumer with whom the universal reward points were shared using another one or more of the predetermined computation parameters, for example, the voucher issuance amount threshold (VIAT) and the voucher issuance percentage (VIP). In an embodiment, the universal rewards management system generates a reward voucher based on reward generation criteria comprising, for example, revenue computed by the universal rewards management system using one or more predetermined computation parameters, for example, the VIP, revenue generated by each of the merchants using another one or more of the predetermined computation parameters, for example, the VIAT, and any combination thereof. In an embodiment, the universal rewards management system determines a reward voucher amount or value, for example, using the following formula:

Reward voucher amount=VIAT*VIP

In an example, if the universal rewards management system determines the VIAT as $100 revenue generated by a merchant registered with the universal rewards management system and the VIP as 10%, then the universal rewards management system generates a reward voucher worth 10% of the VIAT, that is, $10 for the merchant for every $100 revenue generated by the merchant from the universal rewards management system.

In an embodiment, as the ecosystem of the universal rewards management system grows, the universal rewards management system determines that a total value of reward vouchers generated by the universal rewards management system is equivalent to a percentage, for example, 10% of the entire revenue transacted through the universal rewards management system. In an embodiment, a percentage, for example, 70% of the generated reward vouchers are redeemable by consumers registered with the universal rewards management system, whereas the remaining percentage, for example, 30% of the generated reward vouchers are used by the universal rewards management system for other business purposes. In other embodiments, the amount of revenue generated by the registered merchants, which the universal rewards management system uses to generate reward vouchers can be increased or decreased, either on a global basis or in a granular manner, in order to accommodate varying requirements from one or more merchants, one or more consumers, or from owners, managers, or administrators of the universal rewards management system.

In an embodiment, the universal rewards management system generates and renders a list of multiple reward vouchers redeemable from the merchants on a graphical user interface (GUI) provided by the universal rewards management system and accessible on the consumer device for facilitating a selection of one of the reward vouchers by the consumer who made the initial purchase or any other consumer for a subsequent purchase made by either consumer. The universal rewards management system stores the generated list of reward vouchers in the rewards management database. In another embodiment, the universal rewards management system facilitates a search for multiple reward vouchers redeemable from the merchants and stored in the rewards management database, via the GUI accessible on the consumer device.

The universal rewards management system receives 106 a reward voucher redemption request for redeeming the generated reward voucher from the consumer device of the consumer who made the initial purchase or any other consumer via the network. The universal rewards management system communicates 107 the received reward voucher redemption request to the merchant device via the network for acquiring a reward voucher redemption approval from the merchant device. The universal rewards management system determines 108 a reduced cost for the subsequent purchase made by the consumer who made the initial purchase or any other consumer based on the acquired reward voucher redemption approval to the reward voucher redemption request. The computer implemented method and the universal rewards management system disclosed herein ensure that the merchants registered with the universal rewards management system honor the reward vouchers purchased by the consumers who are registered with the universal rewards management system. When a reward voucher is purchased by a consumer from a merchant after purchasing a product and/or a service from the merchant, the universal rewards management system deducts an amount of universal reward points equivalent to the reward voucher value from the consumer account. When the reward voucher is used by the consumer, the universal rewards management system ensures that the merchant honors cash discount amounts equivalent to the reward voucher value.

The universal rewards management system implements rules and/or formulae to ensure that the merchants honor their agreed reward voucher value redemption obligation to the universal rewards management system. The agreed reward voucher value redemption obligation is proportional to a purchase transaction amount for a purchase made by a consumer from a merchant. In an embodiment, a total value of universal reward points entitled to the consumers registered with the universal rewards management system is equal to a total value of unpurchased reward vouchers stored in the rewards management database of the universal rewards management system. The universal rewards management system is a self balanced system that provides universal reward points that are exchangeable as a currency, and are backed by the generated reward vouchers.

In an embodiment, the universal rewards management system determines balance universal reward points contained in a consumer account using the purchase transaction information, a number of redeemed reward vouchers, and another one or more of the predetermined computation parameters, for example, the reward point percentage. Consider an example where the purchase transaction amount is $500, the number of redeemed reward vouchers is 5, and the reward point percentage is 10%. The universal rewards management system determines the balance universal reward points in the consumer account to be 45 reward points, for example, by using the following formula:

Consumer reward points balance=SUM (total purchase transaction amount*reward point percentage (RPP))−SUM (number of redeemed reward vouchers)

The universal rewards management system offers universal reward points redeemable not only from the merchant visited by the consumer or the merchant from whom the consumer made the purchase, but also from any merchant who participates in the network of the universal rewards management system. Furthermore, the consumer who made the initial purchase or any other consumer with whom the universal reward points are shared can redeem the reward voucher from the merchant who issued the reward voucher. The universal rewards management system achieves universality by creating a network where universal reward points are shared and exchanged among the consumers, and by maintaining an accurate accounting system where total redeemable universal reward points generated by the universal rewards management system are equal to reward vouchers offered by all the merchants in the network in total, and where the reward vouchers offered by each merchant are directly proportional to revenue incurred by the merchant.

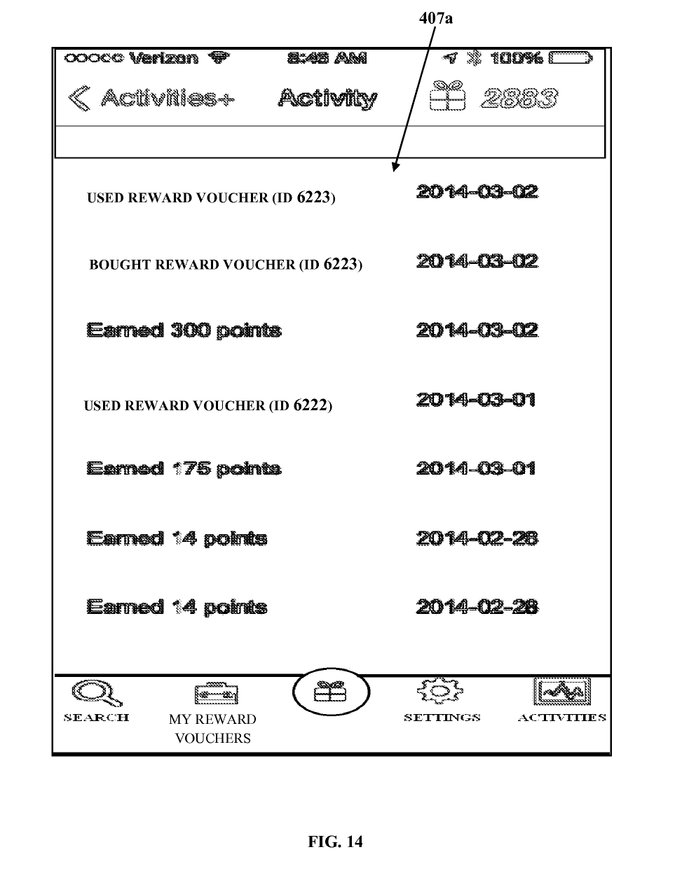

In an embodiment, the universal rewards management system dynamically generates and renders reward management reports to the consumer device and the merchant device via the network. The reward management reports comprise, for example, one or more of information associated with the generated universal reward points, the generated universal reward points approved by the merchant, the generated reward voucher, a redemption status of the generated reward voucher, etc., or any combination thereof. In an embodiment, the reward management reports are displayed as lists on the GUI of the universal rewards management system as exemplarily illustrated in FIG. 14. In an embodiment, the universal rewards management system generates and transmits notifications to the consumer device and the merchant device, for indicating actions associated with the management of the collection and the redemption of the universal rewards performed by the universal rewards management system. For example, the universal rewards management system transmits notifications to a consumer device on acceptance or denial of a reward voucher redemption request by a merchant, on successful establishment of communication between the consumer device and the merchant device, etc.

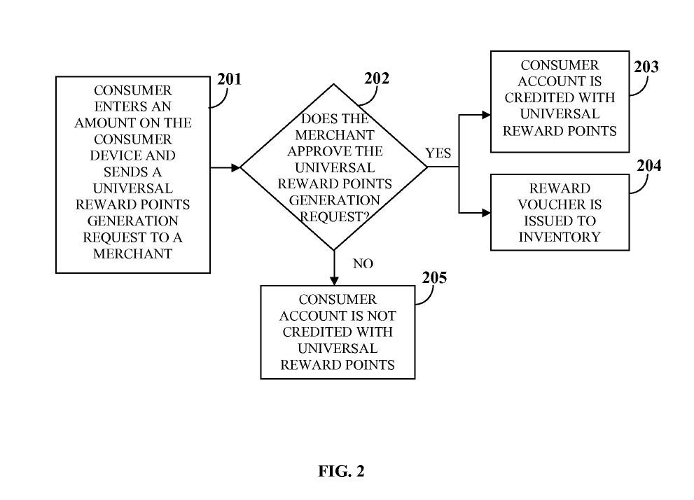

FIG. 2 exemplarily illustrates a flowchart comprising the steps for collecting universal reward points by a consumer. Consider an example where the consumer purchases a product at a merchant location and wants to earn universal reward points for the purchased product. The consumer downloads the consumer rewards management application on the consumer device to enable the consumer to earn universal reward points for every purchase at the merchant location. The consumer enters 201 an amount of a purchase transaction for the purchased product on a graphical user interface (GUI) provided by the consumer rewards management application on the consumer device and sends 201 a universal reward points generation request to a merchant device via the universal rewards management system. The universal rewards management system receives the universal reward points generation request from the consumer device and transmits the universal reward points generation request to the merchant device after establishing a communication channel between the consumer device and the merchant device.

The merchant receives the universal reward points generation request on the graphical user interface (GUI) of the merchant rewards management application on the merchant device. The reward generation request comprises, for example, the type of request such as a request to earn universal reward points, a transaction identifier (ID), a transaction amount, a consumer identifier (ID), and a consumer name. The universal rewards management system transmits the universal reward points generation request to the merchant device to enable verification of the transaction ID with the merchant device. The merchant decides 202 to approve or deny the universal reward points generation request based on verification of the transaction ID. If the merchant approves the universal reward points generation request on the merchant device after verifying the transaction ID and the consumer name, the universal rewards management system receives a transaction approval request or a reward generation approval from the merchant device.

On receiving the transaction approval request from the merchant device, the universal rewards management system approves the transaction approval request and generates and credits 203 universal reward points to the consumer account. The consumer can use the universal reward points to obtain, for example, cash rewards on approval of the transaction by the merchant. The universal rewards management system further renders a redeemable reward voucher amount to a merchant account and issues 204 a reward voucher to an inventory of the merchant. The universal rewards management system further transmits notifications to the consumer device and the merchant device via the network on successful completion of the universal reward points generation request. If the merchant denies the universal reward points generation request on the merchant device, the universal rewards management system receives a transaction denial request from the merchant device. The universal rewards management system then denies the transaction and transmits a denied transaction status notification to the merchant device and the consumer device via the network. In this case, the consumer does not earn any universal reward points and the universal rewards management system does not credit 205 universal reward points to the consumer account.

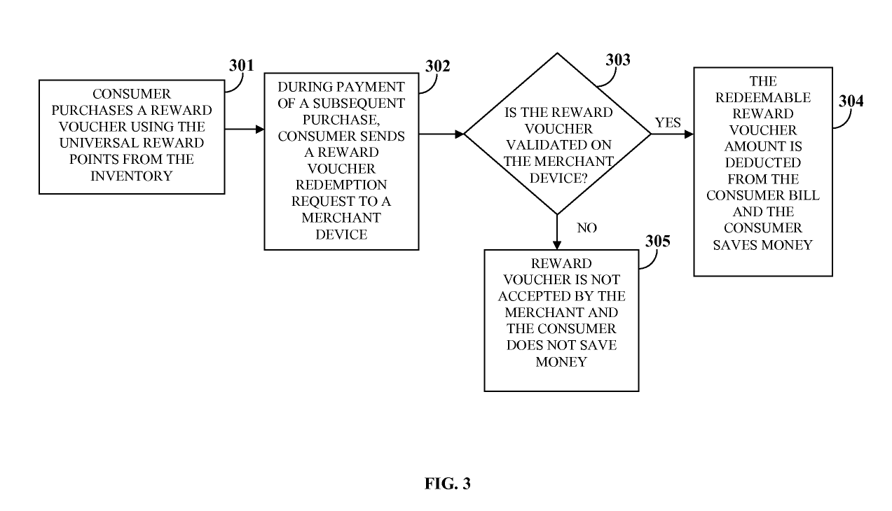

FIG. 3 exemplarily illustrates a flowchart comprising the steps for redeeming a reward voucher at a merchant location. Consider an example where a consumer wants to purchase a reward voucher using universal reward points and redeem the reward voucher for a subsequent purchase of a product or a service at a merchant location. The consumer invokes the consumer rewards management application on the consumer device and searches via a search query for a reward voucher of a particular merchant. The universal rewards management system receives the search query and renders a list of reward vouchers issued by that merchant on the graphical user interface (GUI) of the consumer rewards management application. When the consumer selects a reward voucher from the rendered list of reward vouchers, the consumer rewards management application renders details of the selected reward voucher on the GUI. The consumer purchases 301 the selected reward voucher using the universal reward points from an inventory of the universal rewards management system. The consumer sends 302 a reward voucher redemption request to a merchant device of that particular merchant, while making a payment for a subsequent purchase of a product or a service at the merchant location. The universal rewards management system transmits the reward voucher redemption request to the merchant device via the network. The merchant decides 303 to approve or deny the reward voucher redemption request based on validation of a transaction ID provided in the reward voucher redemption request. If the merchant approves the reward voucher redemption request, the universal rewards management system deducts 304 the redeemable reward voucher amount associated with the reward voucher redemption request, from a consumer bill and the consumer saves money. When the merchant denies the reward voucher redemption request and the reward voucher is not accepted 305 by the merchant, the consumer does not save money. The universal rewards management system transmits a denied reward voucher redemption status notification to the consumer device and the merchant device via the network.

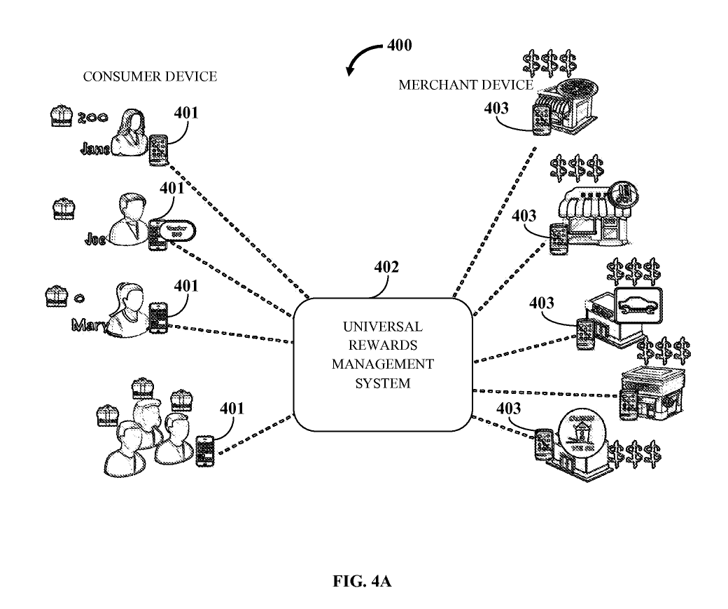

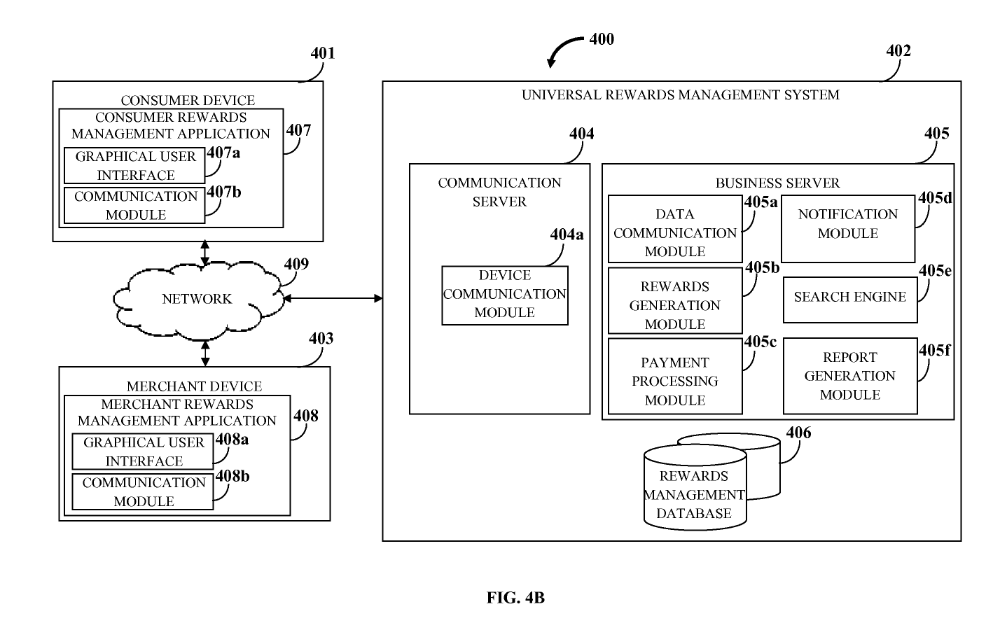

FIG. 4A exemplarily illustrates a computer implemented system 400 showing communication between the universal rewards management system 402, a consumer device 401, and a merchant device 403 for managing collection and redemption of universal rewards. The consumer device 401 communicates with the merchant device 403 via the universal rewards management system 402 for requesting for universal reward points generation for each purchase of products and/or services at a merchant location, for requesting for reward vouchers corresponding to the generated universal reward points, for requesting for reward voucher redemption, for inviting a merchant to register with the universal rewards management system 402 to allow the consumer to become an ambassador of the merchant, etc.

FIG. 4B exemplarily illustrates the computer implemented system 400 for managing collection and redemption of universal rewards. The computer implemented system 400 disclosed herein comprises the universal rewards management system 402 accessible by a consumer device 401 and a merchant device 403 via a network 409. The universal rewards management system 402 is accessible to the consumer device 401 and the merchant device 403, for example, through a broad spectrum of technologies and devices such as personal computers with access to the internet, internet enabled cellular phones, tablet computing devices, wearable computing devices such as such as Google Glass of Google Inc., etc. In an embodiment, the universal rewards management system 402 is configured as a web based platform, for example, a website hosted on a server or a network of servers. In another embodiment, the universal rewards management system 402 provides software applications, for example, the consumer rewards management application 407 and the merchant rewards management application 408 downloadable and usable on the consumer device 401 and the merchant device 403 respectively. In another embodiment, the universal rewards management system 402 is implemented in a cloud computing environment. As used herein, “cloud computing environment” refers to a processing environment comprising configurable computing physical and logical resources, for example, networks, servers, storage, applications, services, etc., and data distributed over the network 409, for example, the internet. The cloud computing environment provides on-demand network access to a shared pool of the configurable computing physical and logical resources. The universal rewards management system 402 is developed, for example, using the Google App engine cloud infrastructure of Google Inc., the Amazon Web Services® of Amazon Technologies, Inc., the Amazon elastic compute cloud EC2® web service of Amazon Technologies, Inc., the Android platform of Google Inc., the iOS platform of Apple Inc., the Google® Cloud platform of Google Inc., the Microsoft® Cloud platform of Microsoft Corporation, etc. In an embodiment, the universal rewards management system 402 is configured as a cloud computing based platform implemented as a service for enabling collection and redemption of universal rewards.

The consumer device 401 and the merchant device 403 can be mobile computing devices, for example, notebooks, tablet computing devices, mobile computers, mobile phones, smart phones, portable computing devices, laptops, personal digital assistants, wearable devices such as Google Glass™ of Google Inc., Apple Watch™ of Apple Inc., etc., touch centric devices, workstations, client devices, portable electronic devices, network enabled computing devices, interactive network enabled communication devices, any other suitable computing equipment, and combinations of multiple pieces of computing equipment capable of running the consumer rewards management application 407 and the merchant rewards management application 408. The network 409 for accessing the universal rewards management system 402 is, for example, the internet, an intranet, a wired network, a wireless network, a communication network that implements Bluetooth® of Bluetooth Sig, Inc., a network that implements Wi-Fi® of Wi-Fi Alliance Corporation, an ultra-wideband communication network (UWB), a wireless universal serial bus (USB) communication network, a communication network that implements ZigBee® of ZigBee Alliance Corporation, a general packet radio service (GPRS) network, a mobile telecommunication network such as a global system for mobile (GSM) communications network, a code division multiple access (CDMA) network, a third generation (3G) mobile communication network, a fourth generation (4G) mobile communication network, a long-term evolution (LTE) mobile communication network, a public telephone network, etc., a local area network, a wide area network, an internet connection network, an infrared communication network, etc., or a network formed from any combination of these networks.

The consumer rewards management application 407 of the consumer device 401 comprises a graphical user interface (GUI) 407a and a communication module 407b. A consumer enters requests, for example, communication requests, authenticated “earn reward point” transaction requests, and reward voucher redemption requests via the GUI 407a of the consumer rewards management application 407. The GUI 407a of the consumer rewards management application 407 is, for example, a webpage of a website hosted by the universal rewards management system 402, an online web interface, a web based downloadable application interface, a mobile based downloadable application interface, etc. The communication module 407b of the consumer rewards management application 407 transmits a communication request to the universal rewards management system 402 via the network 409 to establish a communication channel with the universal rewards management system 402 for transmission of the requests to the universal rewards management system 402. The merchant rewards management application 408 of the merchant device 403 comprises a GUI 408a and a communication module 408b. The GUI 408a of the merchant rewards management application 408 is, for example, a webpage of a website hosted by the universal rewards management system 402, an online web interface, a web based downloadable application interface, a mobile based downloadable application interface, etc. A merchant enters, for example, communication requests, reward generation approvals or denials, reward voucher redemption approvals or denials, etc., via the GUI 408a of the merchant rewards management application 408. The communication module 408b of the merchant rewards management application 408 transmits a communication request to the universal rewards management system 402 via the network 409 to establish a communication channel with the universal rewards management system 402 for transmission of the approvals, denials, etc., to the universal rewards management system 402. The GUIs 407a and 408a are interoperable with a web based version of the universal rewards management system 402.

In an embodiment, the universal rewards management system 402 comprises a server or a network of servers comprising, for example, a communication server 404 and a business server 405. In an embodiment, the communication server 404 and the business server 405 are implemented using one or more physical machines in a cloud computing environment. The communication server 404 facilitates communication between the consumer rewards management application 407 installed on the consumer device 401 and the merchant rewards management application 408 installed on the merchant device 403 via the network 409. The business server 405 manages collection and redemption of universal rewards. The universal rewards management system 402 disclosed herein further comprises a non-transitory computer readable storage medium and at least one processor communicatively coupled to the non-transitory computer readable storage medium. As used herein, “non-transitory computer readable storage medium” refers to all computer readable media, for example, non-volatile media such as optical discs or magnetic disks, volatile media such as a register memory, a processor cache, etc., and transmission media such as wires that constitute a system bus coupled to the processor, except for a transitory, propagating signal. The non-transitory computer readable storage medium is configured to store computer program instructions defined by modules, for example, 404a, 405a, 405b, 405c, 405d, 405e, 405f, etc., of the universal rewards management system 402. The processor is configured to execute the defined computer program instructions.

The universal rewards management system 402 further comprises a device communication module 404a, a data communication module 405a, a rewards generation module 405b, a payment processing module 405c, and a rewards management database 406. As exemplarily illustrated in FIG. 4B, the device communication module 404a is implemented by the communication server 404, while the data communication module 405a, the rewards generation module 405b, and the payment processing module 405c are implemented by the business server 405. The device communication module 404a communicates with the communication module 407b on the consumer device 401 and the communication module 408b on the merchant device 403 to establish a communication channel between the consumer device 401 and the merchant device 403 based on communication criteria, on receiving communication requests from each of the consumer device 401 and the merchant device 403 via the network 409.

The data communication module 405a communicates purchase transaction information associated with a purchase made by a consumer, received from the consumer device 401 to the merchant device 403 via the network 409, for acquiring a reward generation approval from the merchant device 403. The rewards generation module 405b generates universal reward points for the purchase made by the consumer using the purchase transaction information and one or more of multiple predetermined computation parameters based on the reward generation approval acquired from the merchant device 403. The rewards generation module 405b generates universal reward points that are redeemable for any reward voucher issued by any merchant. The rewards generation module 405b configures the predetermined computation parameters based on merchant inputs received from the merchant device 403 of each of the merchants. In an embodiment, the rewards generation module 405b generates supplementary universal reward points for the consumer on registration of one or more of the merchants invited by the consumer to the universal rewards management system 402. The rewards generation module 405b generates the supplementary universal reward points based on revenue generated by the invited merchants. The rewards generation module 405b maintains a consumer account for the consumer and credits the generated universal reward points to the consumer account. In an embodiment, the rewards generation module 405b transmits a configurable amount of the generated universal reward points from a consumer account of the consumer who made the initial purchase to a consumer account of another consumer based on consumer sharing and exchange inputs received from the consumer device 401. The rewards generation module 405b determines balance universal reward points contained in a consumer account of the consumer using the purchase transaction information, a number of redeemed reward vouchers, and another one or more of the predetermined computation parameters.

The rewards generation module 405b maintains a merchant account for each of the merchants. The rewards generation module 405b determines a redeemable reward voucher amount for the merchant corresponding to the generated universal reward points for the purchase made by the consumer using another one or more of the predetermined computation parameters. The rewards generation module 405b renders the determined redeemable reward voucher amount to the merchant account of the merchant associated with the purchase for the generation of the reward voucher for the subsequent purchase made by the consumer who made the initial purchase or any other consumer.

The rewards generation module 405b generates a reward voucher redeemable from the merchant associated with the initial purchase, for a subsequent purchase made by any consumer using another one or more of the predetermined computation parameters. The rewards generation module 405b determines a number of reward vouchers issued to each of the merchants using the purchase transaction information and another one or more of the predetermined computation parameters. In an embodiment, the universal rewards management system 402 further comprises a search engine 405e for facilitating a search for multiple reward vouchers redeemable from the merchants and stored in the rewards management database 406, via the GUI 407a of the consumer rewards management application 407. As exemplarily illustrated in FIG. 4B, the search engine 405e is implemented by the business server 405. The rewards generation module 405b generates and renders a list of multiple reward vouchers redeemable from the merchants on the GUI 407a of the consumer rewards management application 407 for facilitating a selection of one of the reward vouchers by any consumer for a subsequent purchase made by the consumer.

The rewards generation module 405b stores the generated list of reward vouchers in the rewards management database 406. The rewards management database 406 is, for example, a structured query language (SQL) data store or a not only SQL (NoSQL) data store such as the Microsoft® SQL Server®, the Oracle® servers, the MySQL® database of MySQL AB Company, the mongoDB® of MongoDB, Inc., the Neo4j graph database of Neo Technology Corporation, the Cassandra database of the Apache Software Foundation, the HBase™ database of the Apache Software Foundation, etc. In an embodiment, the rewards management database 406 can also be a location on a file system. In another embodiment, the rewards management database 406 can be remotely accessed by the universal rewards management system 402 via the network 409. In another embodiment, the rewards management database 406 is configured as a cloud based database implemented in a cloud computing environment, where computing resources are delivered as a service over the network 409.

The data communication module 405a communicates a reward voucher redemption request for redeeming the generated reward voucher from the consumer device 401 to the merchant device 403 via the network 409, for acquiring a reward voucher redemption approval from the merchant device 403. The payment processing module 405c determines a reduced cost for the subsequent purchase made by any consumer based on the acquired reward voucher redemption approval to the reward voucher redemption request. In an embodiment, the universal rewards management system 402 further comprises a notification module 405d for generating and transmitting notifications to the consumer device 401 and the merchant device 403, for indicating actions associated with the management of the collection and the redemption of the rewards. As exemplarily illustrated in FIG. 4B, the notification module 405d is implemented by the business server 405. The universal rewards management system 402 renders the notifications on the GUIs 407a and 408a of the consumer rewards management application 407 and the merchant rewards management application 408 respectively. In an embodiment, the universal rewards management system 402 further comprises a report generation module 405f for dynamically generating and rendering reward management reports to the consumer device 401 and the merchant device 403 via the network 409. As exemplarily illustrated in FIG. 4B, the report generation module 405f is implemented by the business server 405.

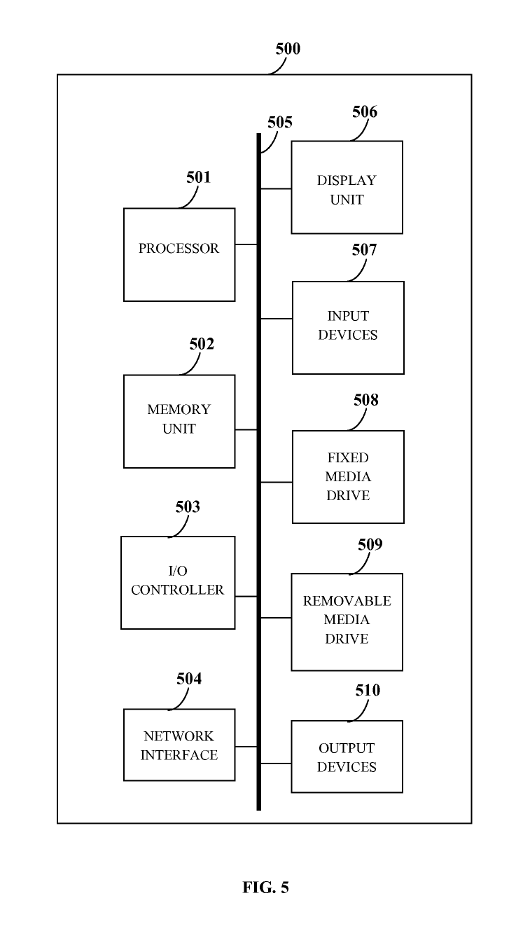

FIG. 5 exemplarily illustrates the hardware architecture 500 of the universal rewards management system 402 exemplarily illustrated in FIG. 4B, employed for managing collection and redemption of universal rewards. The universal rewards management system 402 is a computer system that is programmable using a high level computer programming language. The universal rewards management system 402 may be implemented using programmed and purposeful hardware. The universal rewards management system 402 is accessible by a consumer device 401 and a merchant device 403 over the network 409 exemplarily illustrated in FIG. 4B, for example, a short range network or a long range network.

As exemplarily illustrated in FIG. 5, the hardware architecture 500 of the universal rewards management system 402 comprises a processor 501, a non-transitory computer readable storage medium such as a memory unit 502 for storing programs and data, an input/output (I/O) controller 503, a network interface 504, a data bus 505, a display unit 506, input devices 507, a fixed media drive 508 such as a hard drive, a removable media drive 509 for receiving removable media, output devices 510, etc. The processor 501 refers to any one or more microprocessors, central processing unit (CPU) devices, finite state machines, computers, microcontrollers, digital signal processors, logic, a logic device, an electronic circuit, an application specific integrated circuit (ASIC), a field-programmable gate array (FPGA), a chip, etc., or any combination thereof, capable of executing computer programs or a series of commands, instructions, or state transitions. The processor 501 may also be implemented as a processor set comprising, for example, a general purpose microprocessor and a math or graphics co-processor. The processor 501 is selected, for example, from the Intel® processors such as the Itanium® microprocessor or the Pentium® processors, Advanced Micro Devices (AMD®) processors such as the Athlon® processor, UltraSPARC® processors, microSPARC® processors, Hp® Processors, International Business Machines (IBM®) processors such as the PowerPC® microprocessor, the MIPS® reduced instruction set computer (RISC) processor of MIPS Technologies, Inc., RISC based computer processors of ARM Holdings, Motorola® processors, Qualcomm® processors, etc. The universal rewards management system 402 disclosed herein is not limited employing a processor 501. The universal rewards management system 402 may also employ a controller or a microcontroller. The processor 501 executes the modules, for example, 404a, 405a, 405b, 405c, 405d, 405e, 405f, etc., of the universal rewards management system 402.

The memory unit 502 is used for storing programs, applications, and data. For example, the device communication module 404a, the data communication module 405a, the rewards generation module 405b, the payment processing module 405c, the notification module 405d, the search engine 405e, the report generation module 405f, etc., of the universal rewards management system 402 are stored in the memory unit 502 of the universal rewards management system 402. The memory unit 502 is, for example, a random access memory (RAM) or another type of dynamic storage device that stores information and instructions for execution by the processor 501. The memory unit 502 also stores temporary variables and other intermediate information used during execution of the instructions by the processor 501. The universal rewards management system 402 further comprises a read only memory (ROM) or another type of static storage device that stores static information and instructions for the processor 501. The I/O controller 503 controls input actions and output actions performed by the universal rewards management system 402.

The network interface 504 enables connection of the universal rewards management system 402 to the network 409. In an embodiment, the network interface 504 is provided as an interface card also referred to as a line card. The network interface 504 comprises, for example, one or more of an infrared (IR) interface, an interface implementing Wi-Fi® of Wi-Fi Alliance Corporation, a universal serial bus (USB) interface, a FireWire® interface of Apple Inc., an Ethernet interface, a frame relay interface, a cable interface, a digital subscriber line (DSL) interface, a token ring interface, a peripheral controller interconnect (PCI) interface, a local area network (LAN) interface, a wide area network (WAN) interface, interfaces using serial protocols, interfaces using parallel protocols, and Ethernet communication interfaces, asynchronous transfer mode (ATM) interfaces, a high speed serial interface (HSSI), a fiber distributed data interface (FDDI), interfaces based on transmission control protocol (TCP)/internet protocol (IP), interfaces based on wireless communications technology such as satellite technology, radio frequency (RF) technology, near field communication, etc. The data bus 505 permits communications between the modules, for example, 404a, 405a, 405b, 405c, 405d, 405e, 405f, etc., of the universal rewards management system 402.

The display unit 506 displays information, display interfaces, user interface elements such as text fields, checkboxes, text boxes, windows, etc., for allowing an administrator of the universal rewards management system 402 to enter information comprising, for example, purchase transaction information of a consumer, values for one or more predetermined computation parameters, registration information of one or more merchants, etc. The display unit 506 comprises, for example, a liquid crystal display, a plasma display, an organic light emitting diode (OLED) based display, etc. The input devices 507 are used for inputting data, for example, values for one or more predetermined computation parameters, registration information of one or more merchants, etc., into the universal rewards management system 402. The input devices 507 are, for example, a keyboard such as an alphanumeric keyboard, a microphone, a joystick, a pointing device such as a computer mouse, a touch pad, a light pen, a physical button, a touch sensitive display device, a track ball, a pointing stick, any device capable of sensing a tactile input, etc.

Computer applications and programs are used for operating the universal rewards management system 402. The programs are loaded onto the fixed media drive 508 and into the memory unit 502 of the universal rewards management system 402 via the removable media drive 509. In an embodiment, the computer applications and programs are loaded directly via the network 409. Computer applications and programs are executed by double clicking a related icon displayed on the display unit 506 using one of the input devices 507. The output devices 510 output the results of operations performed by the universal rewards management system 402. For example, the universal rewards management system 402 displays the reward management reports using the output devices 510.

The processor 501 executes an operating system, for example, the Linux® operating system, the Unix® operating system, any version of the Microsoft® Windows® operating system, the Mac OS of Apple Inc., the IBM® OS/2, VxWorks® of Wind River Systems, Inc., QNX Neutrino® developed by QNX Software Systems Ltd., Palm OS®, the Solaris operating system developed by Sun Microsystems, Inc., the Android operating system, the Windows Phone® operating system of Microsoft Corporation, the BlackBerry® operating system of BlackBerry Limited, the iOS operating system of Apple Inc., the Symbian™ operating system of Symbian Foundation Limited, etc. The universal rewards management system 402 employs the operating system for performing multiple tasks. The operating system is responsible for management and coordination of activities and sharing of resources of the universal rewards management system 402. The operating system further manages security of the universal rewards management system 402, peripheral devices connected to the universal rewards management system 402, and network connections. The operating system employed on the universal rewards management system 402 recognizes, for example, inputs provided by the administrator of the universal rewards management system 402 using one of the input devices 507, the output display, files, and directories stored locally on the fixed media drive 508. The operating system on the universal rewards management system 402 executes different programs using the processor 501. The processor 501 and the operating system together define a computer platform for which application programs in high level programming languages are written.

The processor 501 of the universal rewards management system 402 retrieves instructions defined by the device communication module 404a, the data communication module 405a, the rewards generation module 405b, the payment processing module 405c, the notification module 405d, the search engine 405e, the report generation module 405f, etc., of the universal rewards management system 402 for performing respective functions disclosed in the detailed description of FIG. 4B. The processor 501 retrieves instructions for executing the modules, for example, 404a, 405a, 405b, 405c, 405d, 405e, 405f, etc., of the universal rewards management system 402 from the memory unit 502. A program counter determines the location of the instructions in the memory unit 502. The program counter stores a number that identifies the current position in the program of each of the modules, for example, 404a, 405a, 405b, 405c, 405d, 405e, 405f, etc., of the universal rewards management system 402. The instructions fetched by the processor 501 from the memory unit 502 after being processed are decoded. The instructions are stored in an instruction register in the processor 501. After processing and decoding, the processor 501 executes the instructions, thereby performing one or more processes defined by those instructions.

At the time of execution, the instructions stored in the instruction register are examined to determine the operations to be performed. The processor 501 then performs the specified operations. The operations comprise arithmetic operations and logic operations. The operating system performs multiple routines for performing a number of tasks required to assign the input devices 507, the output devices 510, and memory for execution of the modules, for example, 404a, 405a, 405b, 405c, 405d, 405e, 405f, etc., of the universal rewards management system 402. The tasks performed by the operating system comprise, for example, assigning memory to the modules, for example, 404a, 405a, 405b, 405c, 405d, 405e, 405f, etc., of the universal rewards management system 402, and to data used by the universal rewards management system 402, moving data between the memory unit 502 and disk units, and handling input/output operations. The operating system performs the tasks on request by the operations and after performing the tasks, the operating system transfers the execution control back to the processor 501. The processor 501 continues the execution to obtain one or more outputs. The outputs of the execution of the modules, for example, 404a, 405a, 405b, 405c, 405d, 405e, 405f, etc., of the universal rewards management system 402 are displayed to the user on the display unit 506.

For purposes of illustration, the detailed description refers to the universal rewards management system 402 being run locally as a single computer system; however the scope of the computer implemented method and system 400 disclosed herein is not limited to the universal rewards management system 402 being run locally as a single computer system via the operating system and the processor 501, but may be extended to run remotely over the network 409 by employing a web browser and a remote server, a mobile phone, or other electronic devices. One or more portions of the universal rewards management system 402 may be distributed across one or more computer systems (not shown) coupled to the network 409.

Disclosed herein is also a computer program product comprising a non-transitory computer readable storage medium that stores computer program codes comprising instructions executable by at least one processor 501 for managing collection and redemption of universal rewards. The computer program product disclosed herein comprises a first computer program code for establishing a communication between a consumer device 401 and a merchant device 403 based on communication criteria, on receiving a communication request from each of the consumer device 401 and the merchant device 403 via the network 409; a second computer program code for communicating purchase transaction information associated with a purchase made by a consumer, received from the consumer device 401 to the merchant device 403 via the network 409, for acquiring a reward generation approval from the merchant device 403; a third computer program code for generating universal reward points for the purchase made by the consumer using the purchase transaction information and one or more of multiple predetermined computation parameters based on the reward generation approval acquired from the merchant device 403; a fourth computer program code for generating a reward voucher redeemable from the merchant associated with the purchase, for a subsequent purchase made by any consumer using another one or more of the predetermined computation parameters; a fifth computer program code for communicating a reward voucher redemption request for redeeming the generated reward voucher from the consumer device 401 to the merchant device 403 via the network 409, for acquiring a reward voucher redemption approval from the merchant device 403; and a sixth computer program code for determining a reduced cost for the subsequent purchase made by any consumer based on the acquired reward voucher redemption approval to the reward voucher redemption request.

The computer program product disclosed herein further comprises one or more additional computer program codes for performing additional steps that may be required and contemplated for managing collection and redemption of universal rewards. For example, the computer program product disclosed herein further comprises one or more additional computer program codes for managing issuance of universal reward points, generation of reward vouchers, and maintenance of a consumer account balance and a merchant account balance in the network 409 using the following computations:

Universal reward points=Total purchase transaction amount*reward point percentage (RPP)

Total redeemable reward voucher amount owed by a merchant=Total purchase transaction amount*voucher issuance percentage (VIP)

Number of issued reward vouchers=Modulus (Total purchase transaction amount/Voucher issuance amount threshold (VIAT))

Reward voucher amount=VIAT*VIP

Consumer reward points balance=SUM (total purchase transaction amount*reward point percentage (RRP))−SUM (number of redeemed reward vouchers)

In the above equations, the RRP, the VIAT, and the VIP are configurable by the merchant, and the VIP>=RRP.

In an embodiment, a single piece of computer program code comprising computer executable instructions performs one or more steps of the computer implemented method disclosed herein for managing collection and redemption of universal rewards. The computer program codes comprising computer executable instructions are embodied on the non-transitory computer readable storage medium. The processor 501 of the universal rewards management system 402 retrieves these computer executable instructions and executes them. When the computer executable instructions are executed by the processor 501, the computer executable instructions cause the processor 501 to perform the steps of the computer implemented method for managing collection and redemption of universal rewards.

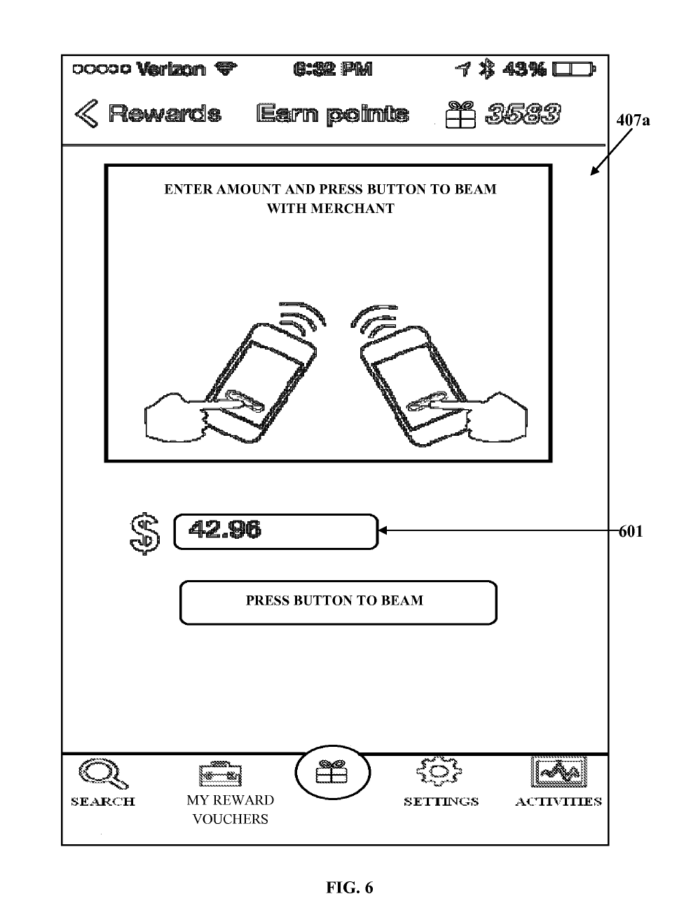

FIGS. 6-45 exemplarily illustrate screenshots of graphical user interfaces (GUIs) 407a and 408a provided by the universal rewards management system 402 exemplarily illustrated in FIG. 4B, for managing collection and redemption of rewards. Consider an example where a consumer purchases a product and wants to collect universal reward points corresponding to all or some of the amount of money paid by the consumer to the merchant for every purchase at a merchant location. The consumer registers with the universal rewards management system 402 and downloads the consumer rewards management application 407 on a consumer device 401 exemplarily illustrated in FIG. 4B, to collect the universal reward points for every purchase at the merchant location. A merchant at the merchant location registers with the universal rewards management system 402 and downloads the merchant rewards management application 408 on a merchant device 403 exemplarily illustrated in FIG. 4B, to approve or deny a reward generation request and a reward voucher redemption request received from the consumer device 401. The consumer invokes the consumer rewards management application 407 on the consumer device 401 and enters purchase transaction information, for example, $42.96 spent for the product in an amount entry field 601 on the GUI 407a of the consumer rewards management application 407 as exemplarily illustrated in FIG. 6, for transmission to the merchant device 403. The merchant invokes the merchant rewards management application 408 on the merchant device 403.

The consumer and the merchant click on beam buttons 701 and 801 on the GUIs 407a and 408a of the consumer rewards management application 407 and the merchant rewards management application 408 respectively as exemplarily illustrated in FIGS. 7-8, to establish a communication between the consumer device 401 and the merchant device 403. By clicking the beam buttons 701 and 801, the consumer rewards management application 407 and the merchant rewards management application 408 respectively, transmit communication requests to the universal rewards management system 402 via the network 409 exemplarily illustrated in FIG. 4B, to establish a communication channel with the communication server 404 of the universal rewards management system 402 exemplarily illustrated in FIG. 4B. The communication server 404 receives the communication requests from the consumer rewards management application 407 and the merchant rewards management application 408 and establishes a communication channel with each of the consumer device 401 and the merchant device 403. The consumer rewards management application 407 and the merchant rewards management application 408, each receives a communication channel identifier (ID) from the communication server 404.

In an embodiment, the consumer rewards management application 407 and the merchant rewards management application 408 send authenticated pairing requests with parameters comprising, for example, current time stamps, current locations such as latitude and longitude, respective communication channel IDs, etc., to the business server 405 of the universal rewards management system 402 exemplarily illustrated in FIG. 4B. Based on the time stamps and locations, the business server 405 makes a pairing decision or matches the pair, records the pairing relationship, exchanges the communication channel IDs with the paired consumer device 401 and merchant device 403, and establishes the communication channel between the consumer device 401 and the merchant device 403. As a result of the pairing, the consumer device 401 and the merchant device 403, each receives the communication channel ID of its peer. The consumer rewards management application 407 on the consumer device 401 creates and transmits an authenticated “earn reward point” transaction request to the business server 405. The business server 405 creates a transaction ID based on the authenticated “earn reward point” transaction request and transmits the transaction ID to the consumer device 401. The consumer rewards management application 407 transmits the purchase transaction information comprising parameters, for example, a type of communication, the transaction ID, a transaction amount spent, a consumer ID, a consumer name, etc., to the merchant device 403 via the established communication channel.

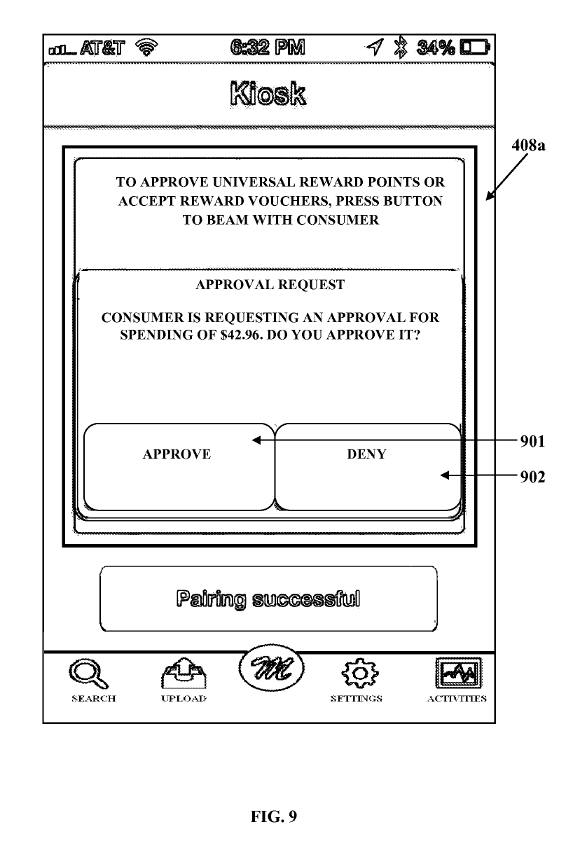

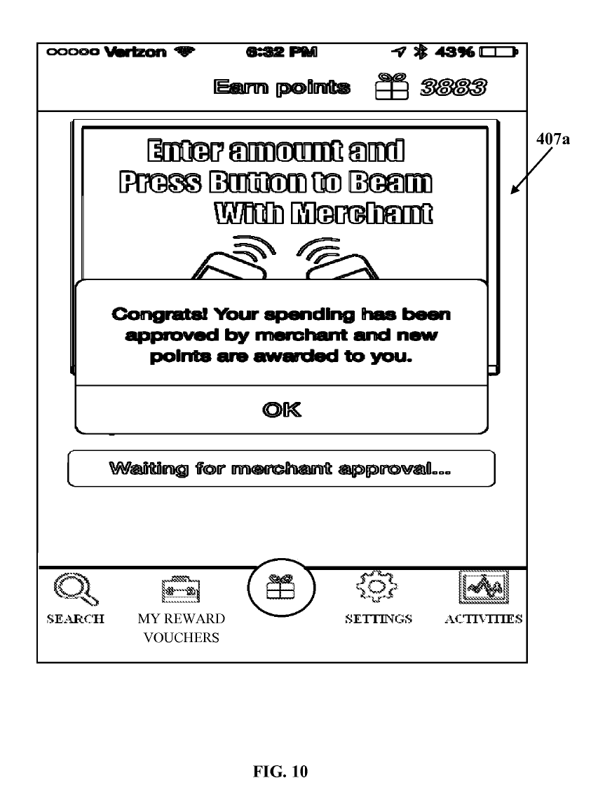

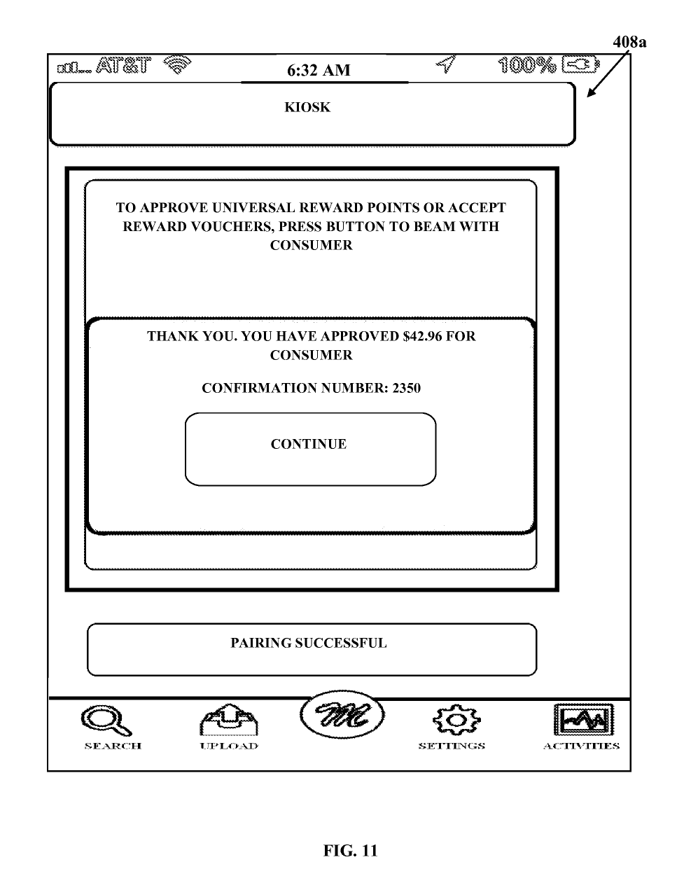

The merchant rewards management application 408 on the merchant device 403 receives the purchase transaction information from the consumer device 401 and validates the transaction ID with the business server 405. The merchant rewards management application 408 renders a message comprising the transaction amount and the consumer name on the GUI 408a of the merchant rewards management application 408 to enable the merchant to approve or deny the “earn reward point” transaction request as exemplarily illustrated in FIG. 9. The merchant can approve or deny the “earn reward point” transaction request on the GUI 408a of the merchant rewards management application 408. If the merchant wants to approve the “earn reward point” transaction request, the merchant clicks on an “Approve” button 901 on the GUI 408a of the merchant rewards management application 408, and the merchant rewards management application 408 sends an authenticated transaction approval request to the business server 405. The business server 405 approves the transaction request and credits corresponding universal reward points to the consumer account. The business server 405 then renders a transaction successful message on the GUI 408a of the merchant rewards management application 408. The merchant rewards management application 408 then transmits a reward generation approval message to the consumer device 401 via the established communication channel. The consumer rewards management application 407 on the consumer device 401 retrieves the latest universal reward points in total from the business server 405 and updates the universal reward points display. The consumer rewards management application 407 on the consumer device 401 and the merchant rewards management application 408 on the merchant device 403 render the reward generation approval message on the GUI 407a of the consumer rewards management application 407 as exemplarily illustrated in FIG. 10, and on the GUI 408a of the merchant rewards management application 408 as exemplarily illustrated in FIG. 11.

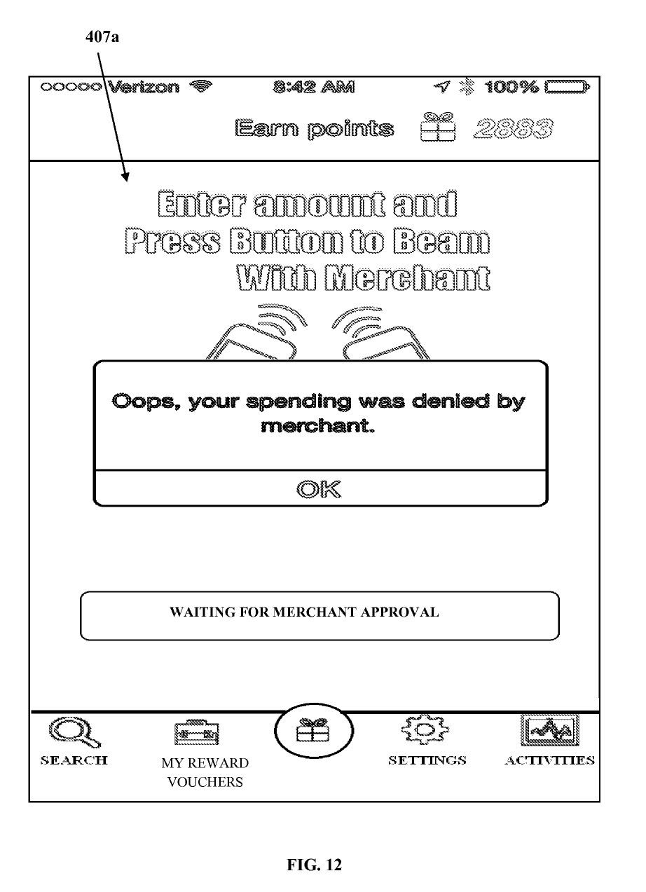

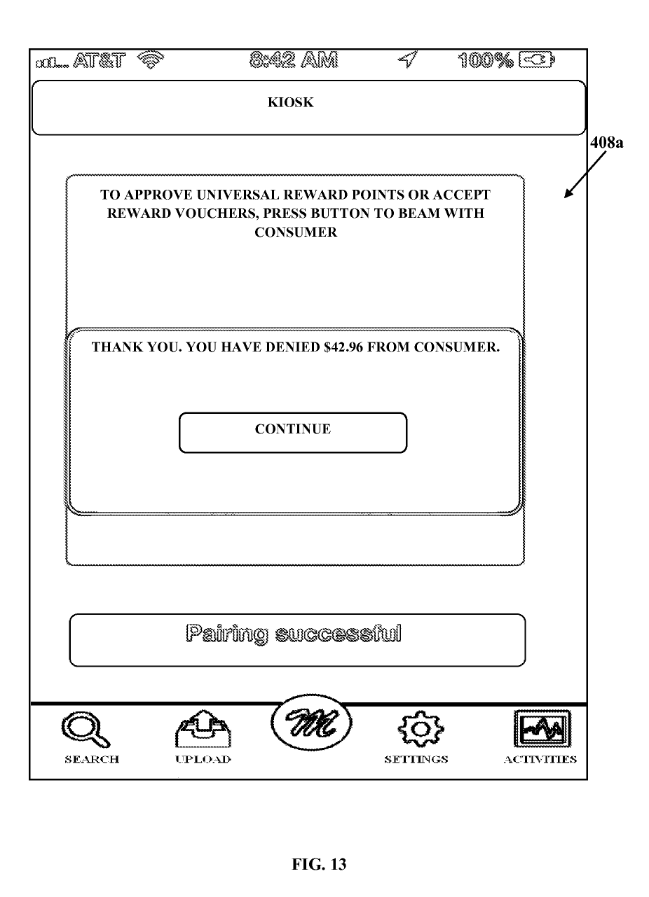

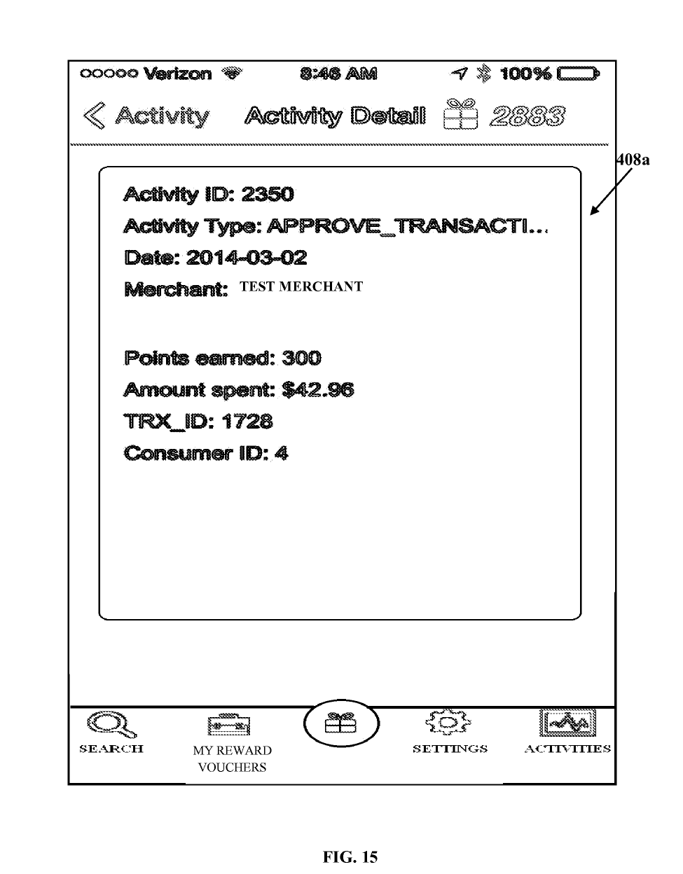

If the merchant wants to deny the “earn reward point” transaction request, the merchant clicks on a “Deny” button 902 on the GUI 408a of the merchant rewards management application 408 as exemplarily illustrated in FIG. 9, and the merchant rewards management application 408 sends an authenticated transaction denial request to the business server 405. The business server 405 denies the transaction request and renders a transaction failed message on the GUI 408a of the merchant rewards management application 408. The merchant rewards management application 408 on the merchant device 403 sends the transaction failed message to the consumer device 401 via the established communication channel. The consumer rewards management application 407 on the consumer device 401 and the merchant rewards management application 408 on the merchant device 403 render a reward generation denial message on the GUI 407a of the consumer rewards management application 407 as exemplarily illustrated in FIG. 12, and on the GUI 408a of the merchant rewards management application 408, exemplarily illustrated in FIG. 13. The approved transaction record for the “earn reward point” transaction request is viewed in an activity history displayed on the GUI 407a of the consumer rewards management application 407 as exemplarily illustrated in FIG. 14, and on the GUI 408a of the merchant rewards management application 408 as exemplarily illustrated in FIG. 15.

Table 1 exemplarily illustrated below is a state table indicating states of the consumer rewards management application 407 and the merchant rewards management application 408 while communicating with the universal rewards management system 402 for a reward generation request.

| Merchant States | Consumer States |
|---|---|
| Merchant_BeamWait | Consumer_BeamWait_Transaction |

| | |
|---|---|
| onload: | onload: |
| event: Beam channel confirm | event: merchant ID received |

| | |
|---|---|
| action: | action: Call ″create transaction″; |
| next: Merchant_RequestWait | next: |

| Merchant_RequestWait | | Consumer_ResultWait_Transaction |
|---|---|---|
| | onload: send merchant ID | Consumer_ResultWait_Transaction |

| | |
|---|---|
| event: transaction ID received | onload: Send transaction ID |

| | |
|---|---|
| action: Call ″get transaction″; | event: ″transaction confirm″ received |

| | |
|---|---|
| next: Merchant_Transaction | action: Display confirmation page |

| | |
|---|---|
| Merchant_Transaction | next: End |

| | |
|---|---|
| onload: Display transaction page | event: ″transaction deny″ received |

| | |
|---|---|
| event: ″confirm″ from transaction page | action: Display deny page |

| | |
|---|---|
| action: Call “approve transaction” | next: End |

send ″transaction confirm″

next: End

event: ″deny″ from transaction page

action: Call “deny transaction”

send ″transaction deny″

next: End

As exemplarily illustrated in Table 1 above, the consumer rewards management application 407 on the consumer device 401 sends a reward generation request to the merchant rewards management application 408 on the merchant device 403 via the universal rewards management system 402 for generation of universal reward points for each purchase of a product at a merchant location. The universal rewards management system 402 transmits the reward generation request to the merchant device 403, while the consumer rewards management application 407 receives a merchant ID and waits for a response from the merchant device 403. The merchant rewards management application 408 on the merchant device 403 receives the reward generation request and validates the reward generation request to enable the merchant to approve or deny the reward generation request. The merchant rewards management application 408 on the merchant device 403 transmits a reward generation approval message or a reward generation denial message to the consumer device 401. The consumer rewards management application 407 on the consumer device 401 renders the reward generation approval message or the reward generation denial message on the GUI 407a of the consumer rewards management application 407, to the consumer. In an embodiment, the consumer can share or exchange the generated universal reward points contained in a consumer account of the consumer to a consumer account of another consumer.

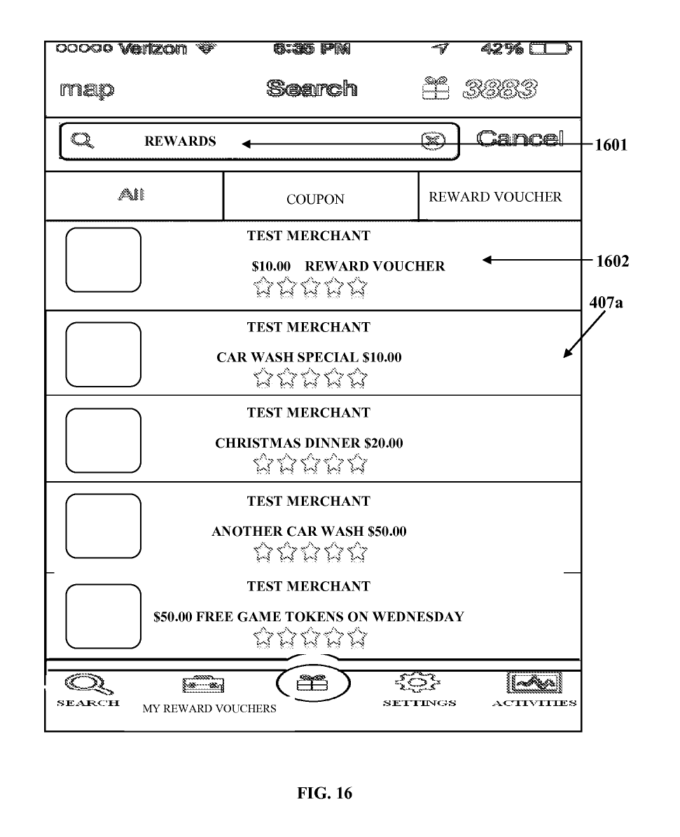

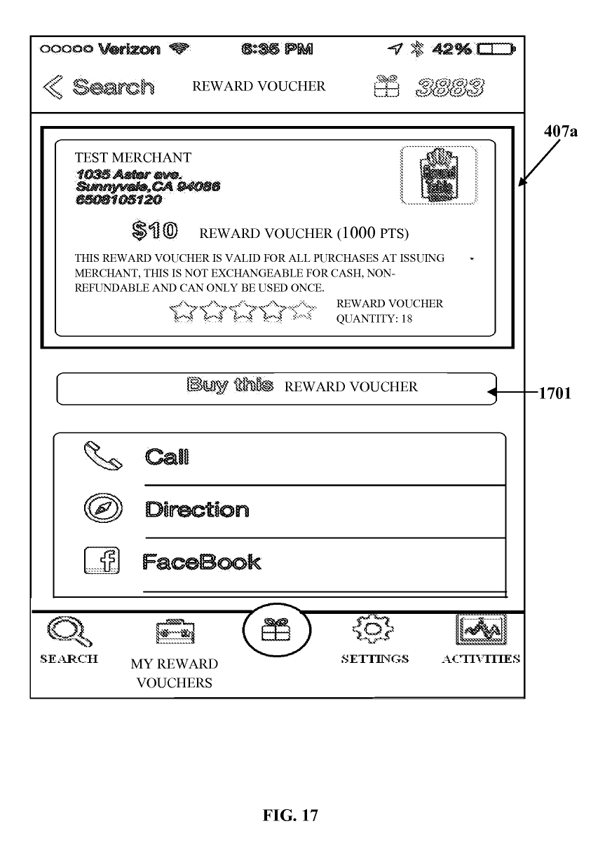

Consider an example where the consumer wants to purchase or buy a reward voucher using the generated universal reward points. The consumer enters a search query with a search keyword in a search field 1601 on the GUI 407a of the consumer rewards management application 407 as exemplarily illustrated in FIG. 16, and searches for a favorite merchant reward voucher. The consumer rewards management application 407 on the consumer device 401 transmits the search query with a current location and the search keyword to the business server 405 of the universal rewards management system 402. The business server 405 generates a list of search results and transmits the search results to the consumer device 401. The consumer rewards management application 407 on the consumer device 401 receives the search results from the business server 405 and renders the search results in order of geographical distance of each merchant location on the GUI 407a of the consumer rewards management application 407 as exemplarily illustrated in FIG. 16. The consumer may select and click on a reward voucher 1602 that he/she wants to purchase on the GUI 407a of the consumer rewards management application 407. The consumer rewards management application 407 displays details of the selected reward voucher as exemplarily illustrated in FIG. 17. The consumer may then click on a “buy this reward voucher” button 1701 on the GUI 407a as exemplarily illustrated in FIG. 17, to purchase the selected reward voucher.

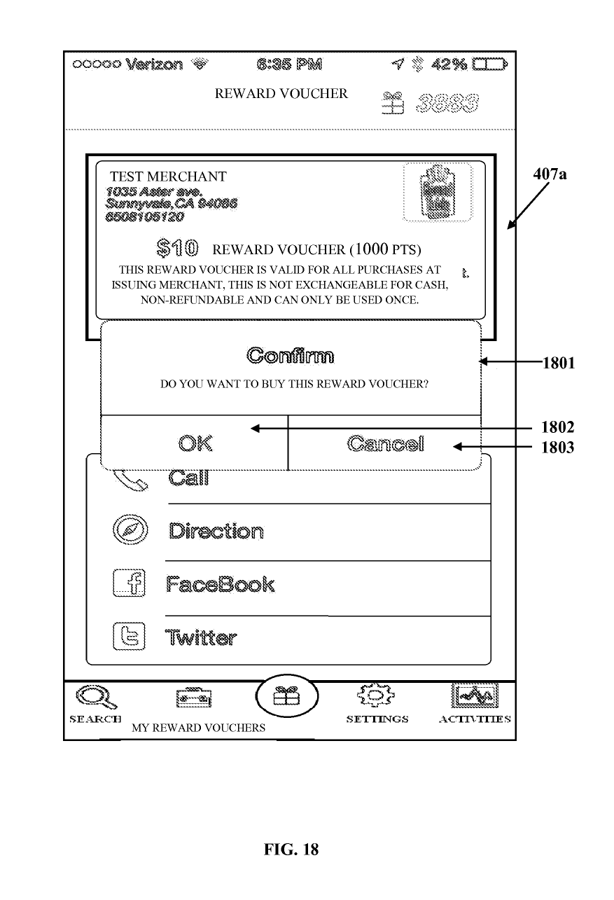

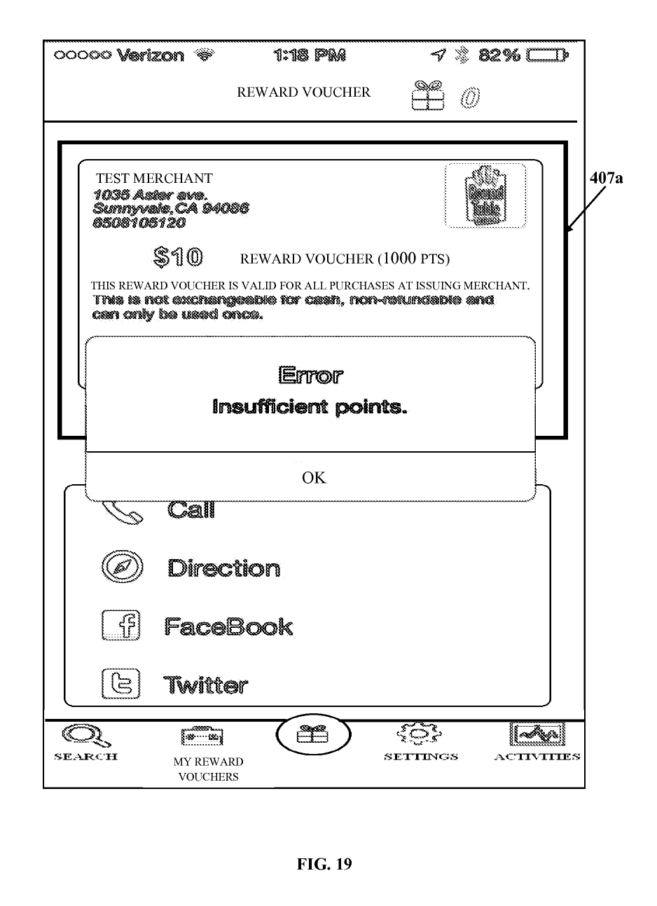

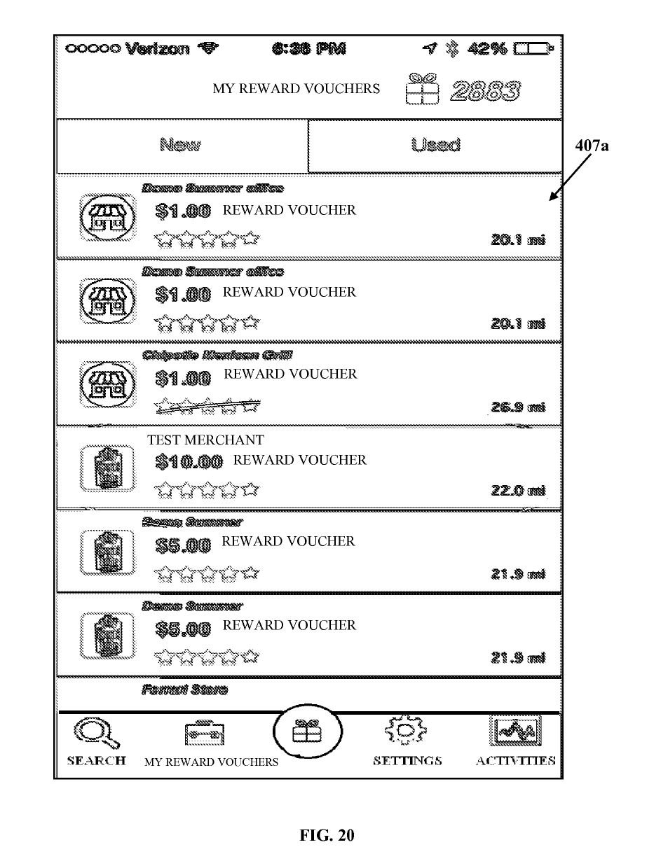

The consumer rewards management application 407 prompts the consumer for confirmation to purchase the reward voucher by displaying a confirmation dialogue box 1801 as exemplarily illustrated in FIG. 18. When the consumer clicks on a “cancel” button 1803 in the confirmation dialogue box 1801, the consumer rewards management application 407 returns to a display interface showing the details of the reward voucher. When the consumer selects an “OK” button 1802 in the confirmation dialogue box 1801, the consumer rewards management application 407 sends an authenticated “buy reward voucher” request to the business server 405 with reward voucher ID information. The business server 405 performs a buy reward voucher operation based on the generated universal reward points of the consumer. One of the following two scenarios happens depending on the number of universal reward points in the consumer account. If the consumer account does not have sufficient universal reward points, the universal rewards management system 402 performs no operation or change to the consumer account and status of the reward voucher. The business server 405 transmits a failed “buy reward voucher” message to the consumer device 401 and the consumer rewards management application 407 displays the failed “buy reward voucher” message indicating insufficient universal reward points on the GUI 407a of the consumer rewards management application 407 as exemplarily illustrated in FIG. 19. If the consumer account has sufficient universal reward points, the business server 405 deducts the generated universal reward points from the consumer account and provides the consumer with the reward voucher. The business server 405 transmits a successful message to the consumer device 401. The consumer rewards management application 407 on the consumer device 401 retrieves a latest status of the generated universal reward points for the consumer and displays the generated universal reward points on the GUI 407a of the consumer rewards management application 407. The consumer rewards management application 407 further retrieves and renders a list of all the current reward vouchers entitled to the consumer along with the latest purchased reward voucher on the GUI 407a of the consumer rewards management application 407 as exemplarily illustrated in FIG. 20.

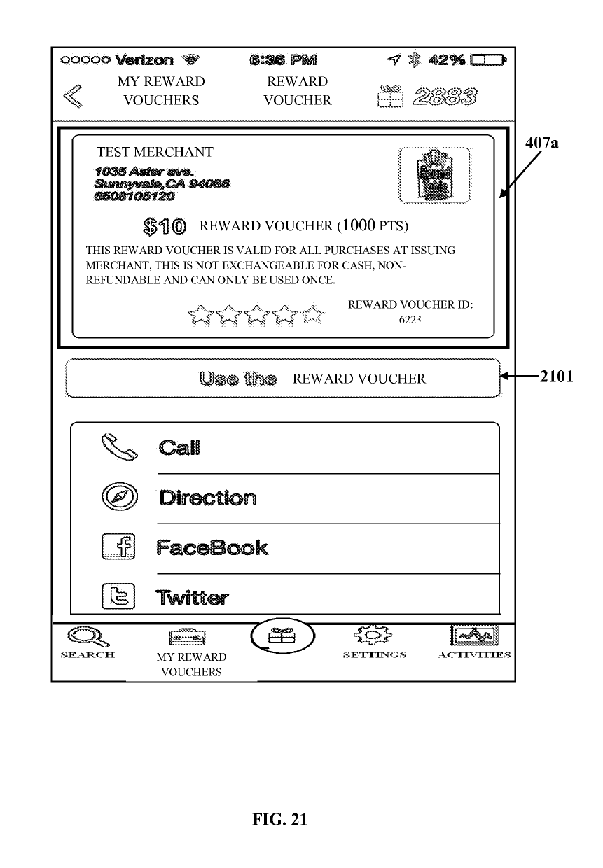

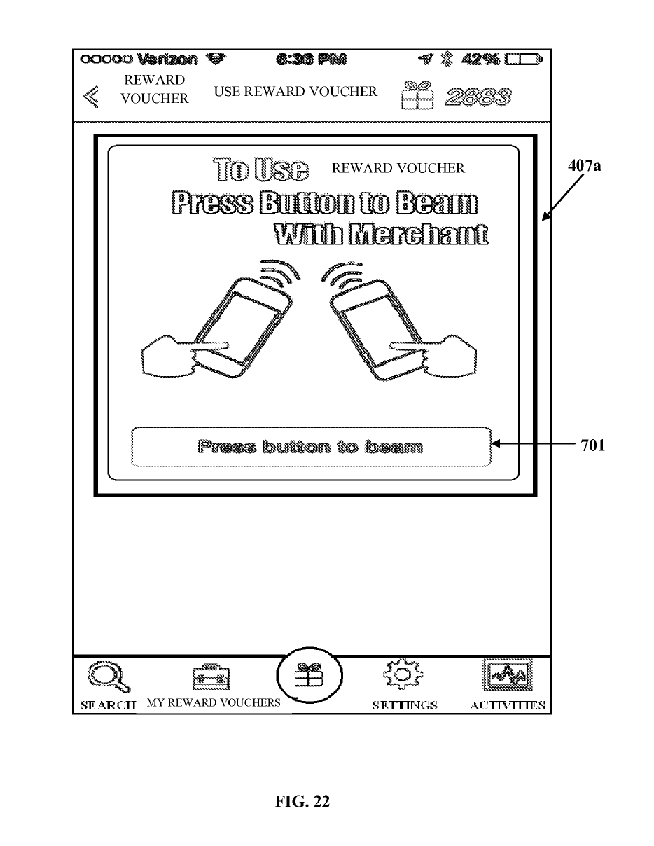

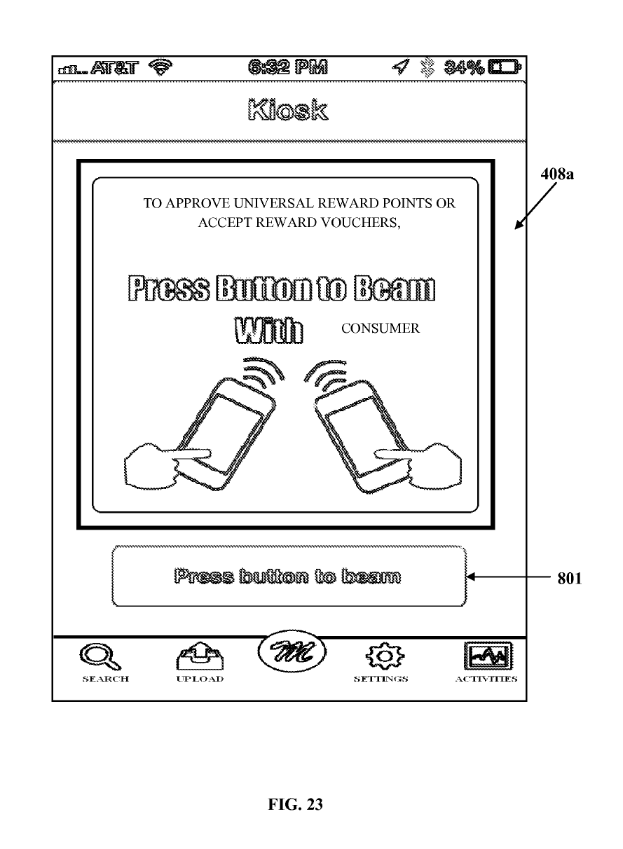

Consider another example where the consumer visits a merchant location and wants to redeem one or more of the entitled reward vouchers towards the price of a product or a service offered by a merchant. The consumer may select an entitled reward voucher that he/she wants to use and click on a “use the reward voucher” button 2101 on the GUI 407a of the consumer rewards management application 407 as exemplarily illustrated in FIG. 21. The consumer and the merchant click on the beam buttons 701 and 801 on the GUI 407a of the consumer rewards management application 407 and the GUI 408a of the merchant rewards management application 408 as exemplarily illustrated in FIGS. 22-23 respectively, to redeem the reward voucher and to approve the redemption of the reward voucher. When the consumer and the merchant click the beam buttons 701 and 801, the consumer rewards management application 407 and the merchant rewards management application 408 send communication requests to the communication server 404 of the universal rewards management system 402 exemplarily illustrated in FIG. 4B. The communication server 404 establishes a communication channel with the consumer rewards management application 407 on the consumer device 401 and the merchant rewards management application 408 on the merchant device 403, and transmits a communication channel identifier (ID) to each of the consumer device 401 and the merchant device 403.

In an embodiment, the consumer rewards management application 407 and the merchant rewards management application 408 send authenticated pairing requests with parameters comprising, for example, current time stamps, current locations such as latitude and longitude, respective communication channel IDs, etc., to the business server 405 of the universal rewards management system 402 exemplarily illustrated in FIG. 4B. The business server 405 makes a pairing decision or matches the pair, records the pairing relationship, and exchanges the communication channel ID information with the paired consumer device 401 and merchant device 403. The business server 405 transmits the communication channel ID of the consumer device 401 to the merchant device 403 and the communication channel ID of the merchant device 403 to the consumer device 401 after establishing communication between the consumer device 401 and the merchant device 403. As a result, the consumer device 401 and the merchant device 403 receive the communication channel ID of its peer from the business server 405.

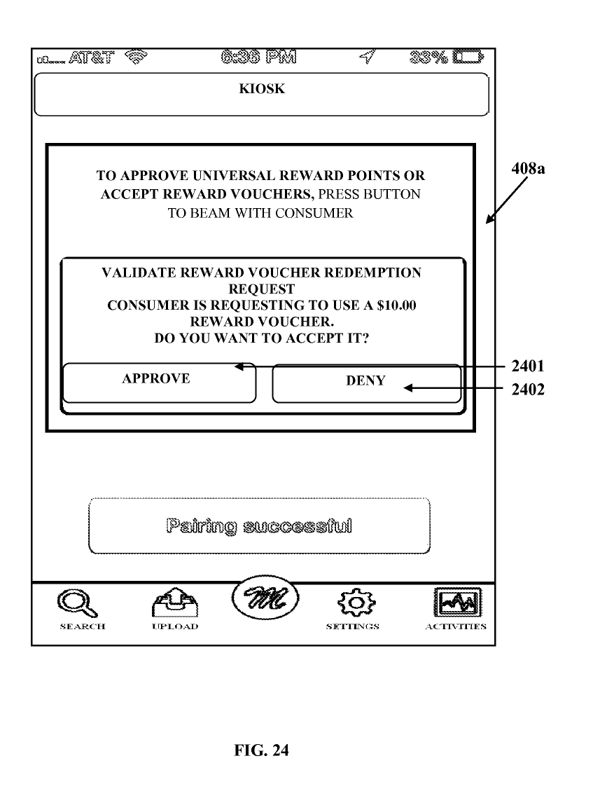

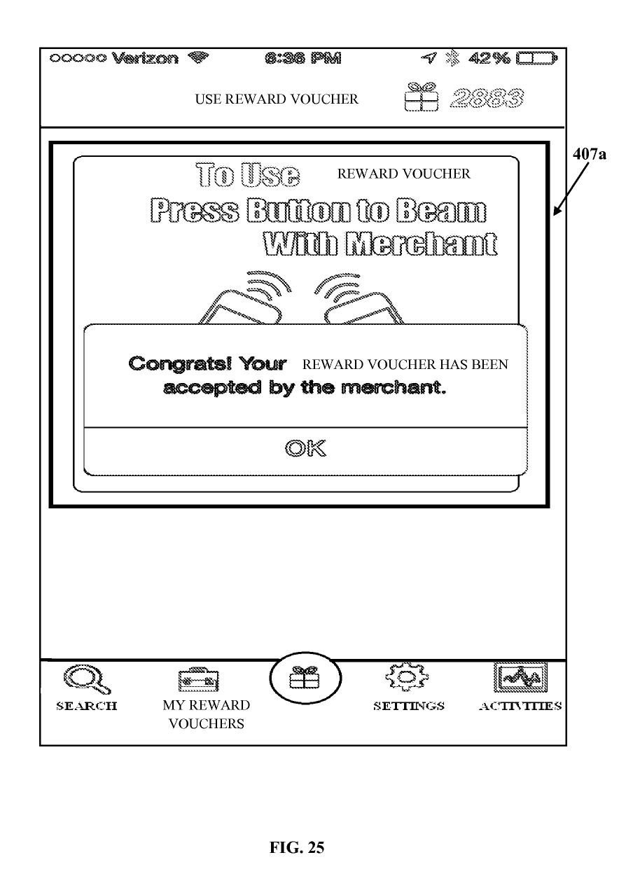

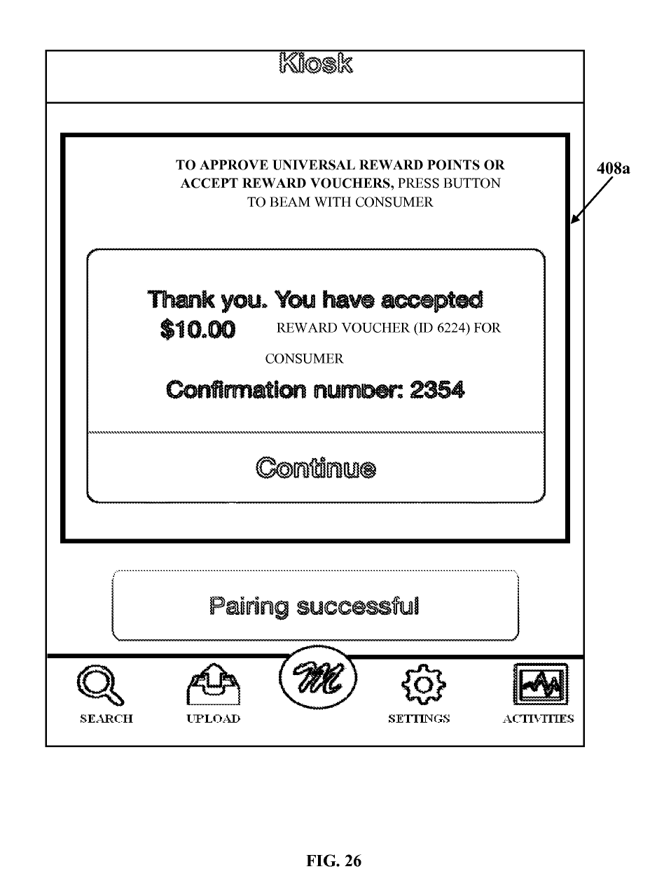

The consumer rewards management application 407 on the consumer device 401 transmits reward voucher redemption information comprising, for example, a type of communication, a reward voucher ID, a sequence number, a consumer ID, a consumer name, etc., to the merchant device 403 via the established communication channel. The merchant rewards management application 408 on the merchant device 403 receives the reward voucher redemption information from the consumer device 401 and prompts the merchant with a message comprising a reward voucher dollar amount and the consumer name on the GUI 408a of the merchant rewards management application 408, to enable the merchant to approve or deny the reward voucher redemption request as exemplarily illustrated in FIG. 24. The merchant can approve or deny the reward voucher redemption request on the GUI 408a of the merchant rewards management application 408. If the merchant clicks on an “Approve” button 2401 on the GUI 408a of the merchant rewards management application 408, the merchant rewards management application 408 sends an authenticated “use reward voucher” request comprising a reward voucher ID and a sequence number to the business server 405. After successful verification of the reward voucher ID and the sequence number, the business server 405 marks the reward voucher as used with the consumer ID and a timestamp. The business server 405 transmits a redemption successful message to the merchant device 403. The merchant rewards management application 408 on the merchant device 403 transmits an approved reward voucher redemption message to the consumer device 401 via the established communication channel. The consumer rewards management application 407 on the consumer device 401 and the merchant rewards management application 408 on the merchant device 403 render a successful reward voucher redemption message on the GUI 407a of the consumer rewards management application 407 as exemplarily illustrated in FIG. 25, and on the GUI 408a of the merchant rewards management application 408 as exemplarily illustrated in FIG. 26.

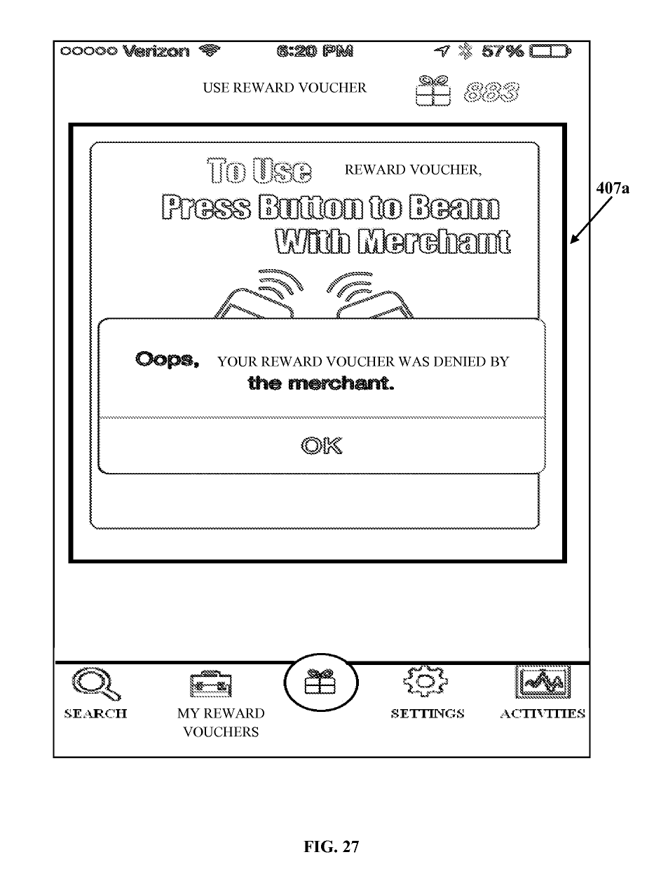

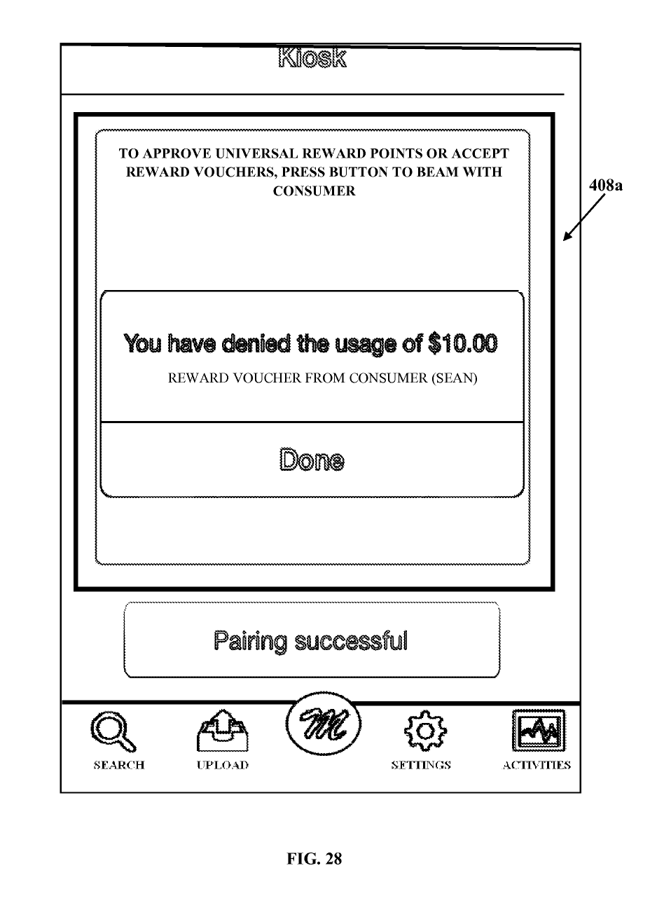

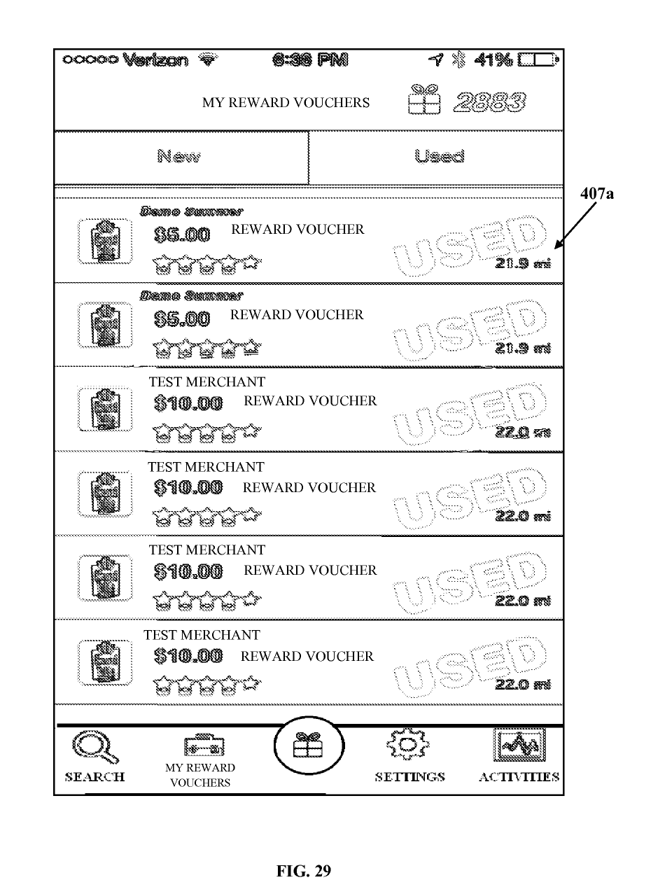

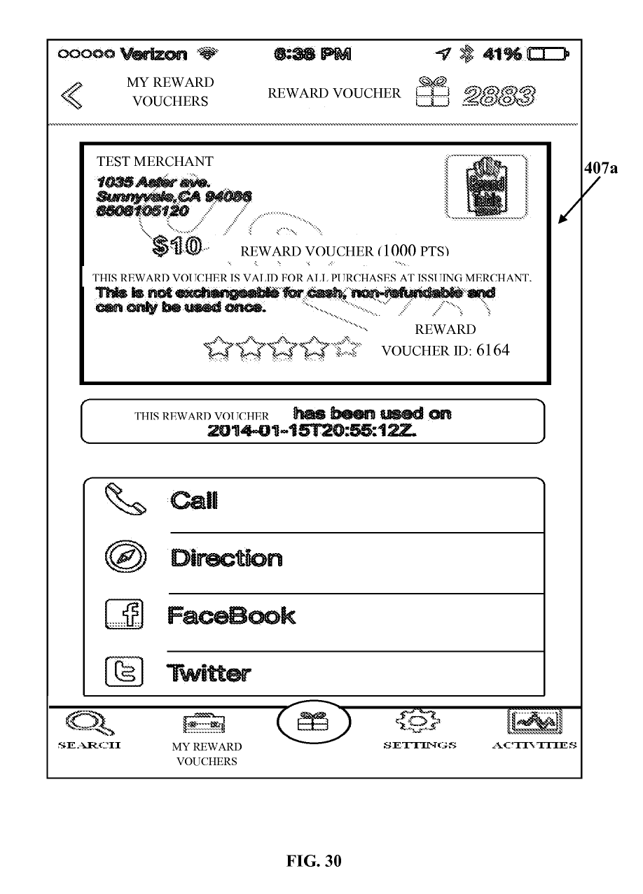

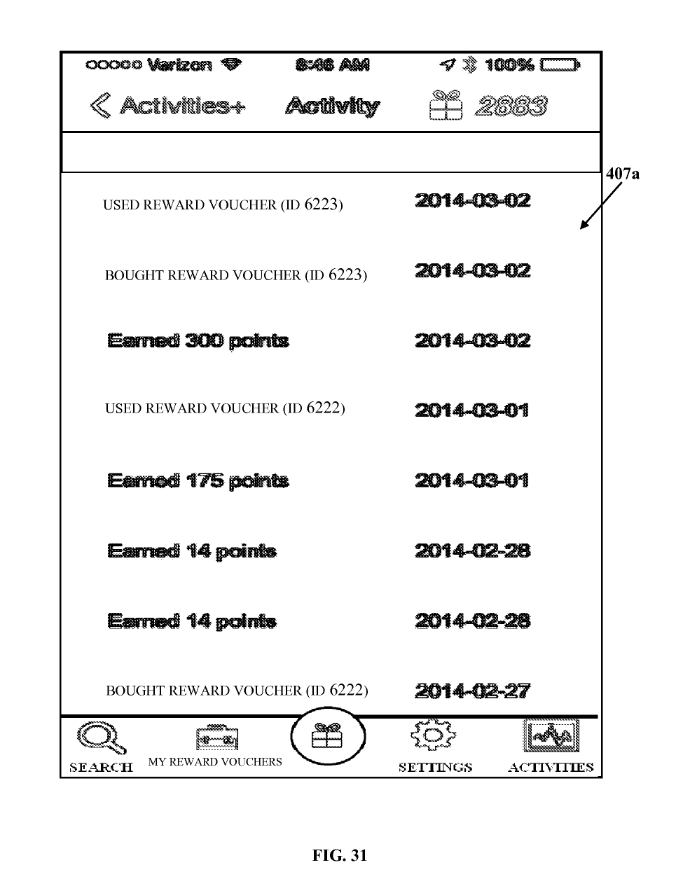

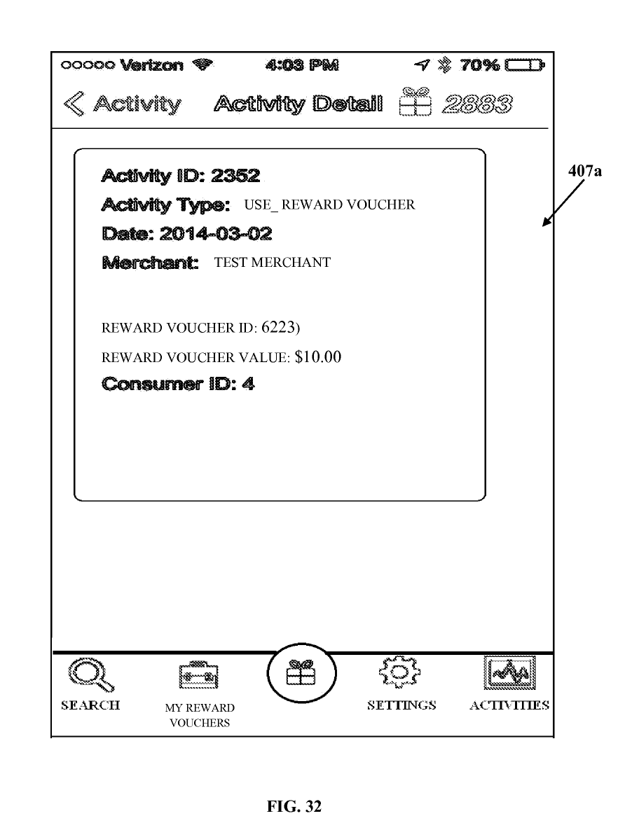

If the merchant clicks on a “Deny” button 2402 on the GUI 408a of the merchant rewards management application 408 exemplarily illustrated in FIG. 24, the merchant rewards management application 408 transmits a denied reward voucher redemption message to the consumer device 401 via the established communication channel. The consumer rewards management application 407 on the consumer device 401 and the merchant rewards management application 408 on the merchant device 403 render a denied reward voucher redemption message on the GUI 407a of the consumer rewards management application 407 as exemplarily illustrated in FIG. 27, and on the GUI 408a of the merchant rewards management application 408 as exemplarily illustrated in FIG. 28. The consumer rewards management application 407 on the consumer device 401 retrieves a reward voucher list comprising a list of new reward vouchers and used reward vouchers from the business server 405 and renders the reward voucher list on the GUI 407a of the consumer rewards management application 407 as exemplarily illustrated in FIG. 29. The consumer may view the list of used reward vouchers on the GUI 407a of the consumer rewards management application 407 as exemplarily illustrated in FIG. 29, and access details of a used voucher on the GUI 407a of the consumer rewards management application 407 as exemplarily illustrated in FIG. 30. The successful reward voucher redemption record is viewed in an activity history displayed on the GUI 407a of the consumer rewards management application 407 as exemplarily illustrated in FIG. 31, and on the GUI 408a of the merchant rewards management application 408 as exemplarily illustrated in FIG. 32.

Table 2 illustrated below is a state table indicating states of the consumer rewards management application 407 and the merchant rewards management application 408 while communicating with the universal rewards management system 402 for a reward voucher redemption request.

| Merchant States | Consumer States |
|---|---|
| Merchant_BeamWait | Consumer_BeamWait_Voucher |

| | |
|---|---|
| onload: | onload: |

| | |
|---|---|
| event: Beam channel confirm | event: merchant ID received |

| | |
|---|---|
| action: | action: |
| next: Merchant_RequestWait | next: |

| Merchant_RequestWait | | Consumer_ResultWait_Voucher |
|---|---|---|
| | onload: send merchant ID | Consumer_ResultWait_Voucher |

| | |
|---|---|
| event: voucher (ID + sequence no) | onload: send voucher |

| | |
|---|---|
| received | event: ″use voucher″ result received |

| | |
|---|---|
| action: Display dialog with “Accept”, | action: Display result page for |

| | |
|---|---|
| “Reject”; | voucher |

| | |
|---|---|
| When press “Accept”, Call ″use | next: End |

voucher″ , and put the result in the context,
with the right reason

When press “Reject”, put the

“voucher deny” result and reason as
“Rejected by merchant”.

next: Merchant_Voucher

Merchant_Voucher

onload: Display “use voucher” result

page

event: ″continue″ from result page

```
  action: send ″use voucher″ result
  next: End
```

As exemplarily illustrated in Table 2 above, the consumer rewards management application 407 on the consumer device 401 sends a reward voucher redemption request to the merchant rewards management application 408 on the merchant device 403 via the universal rewards management system 402 for redeeming the reward voucher. The universal rewards management system 402 transmits the reward voucher redemption request to the merchant device 403, while the consumer rewards management application 407 receives a merchant ID and waits for a response from the merchant device 403. When the merchant rewards management application 408 on the merchant device 403 receives the reward voucher redemption request, the merchant can approve or deny the reward voucher redemption request based on validation of a reward voucher ID and a sequence number. The merchant rewards management application 408 on the merchant device 403 transmits an approved reward voucher redemption message or a denied reward voucher redemption message to the consumer device 401. The consumer rewards management application 407 on the consumer device 401 renders the approved reward voucher redemption message or the denied reward voucher redemption message on the GUI 407a of the consumer rewards management application 407, to the consumer.

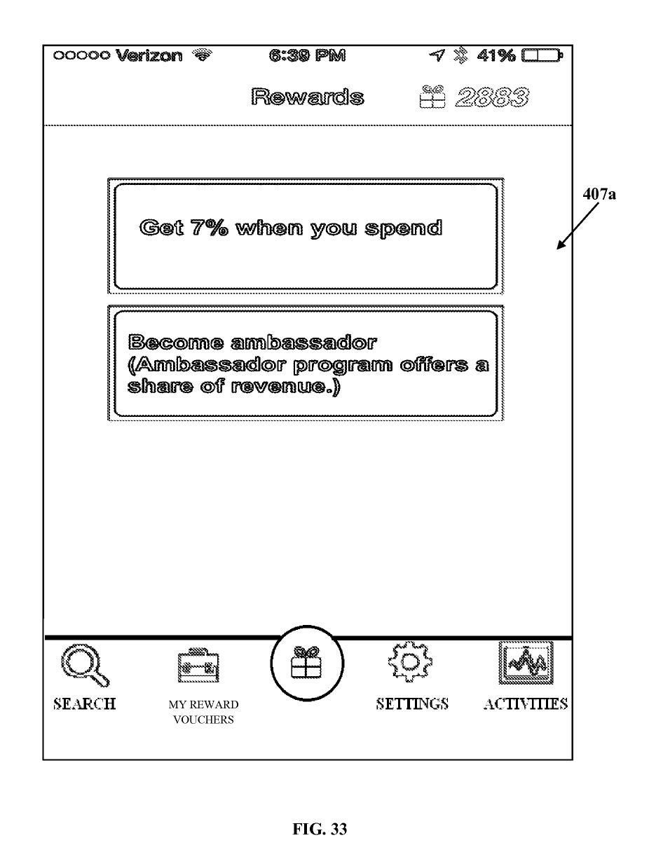

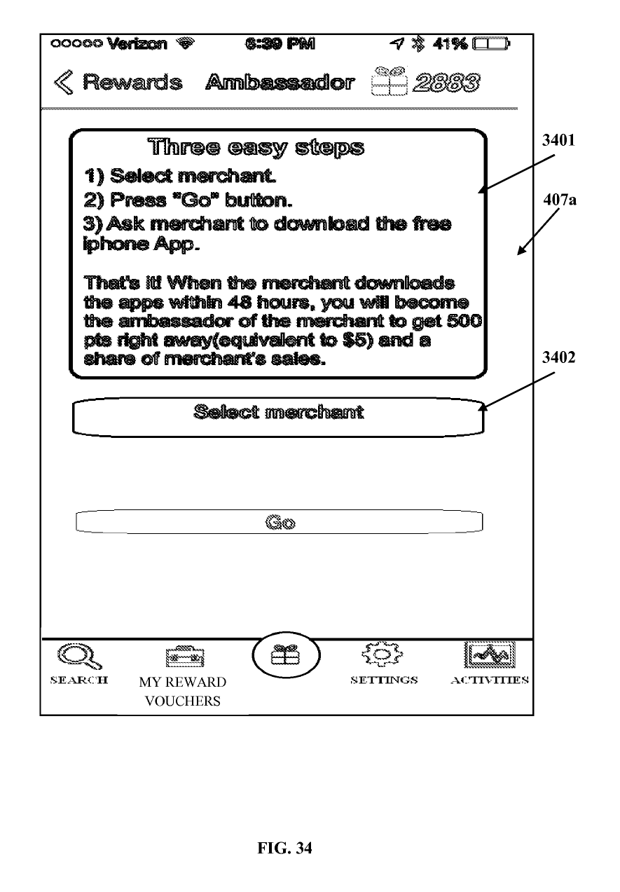

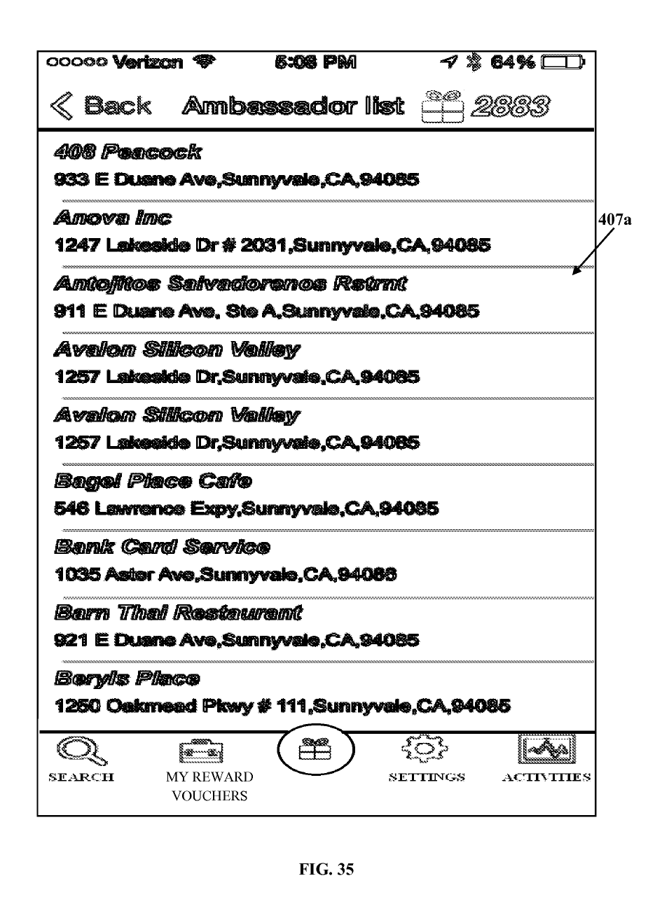

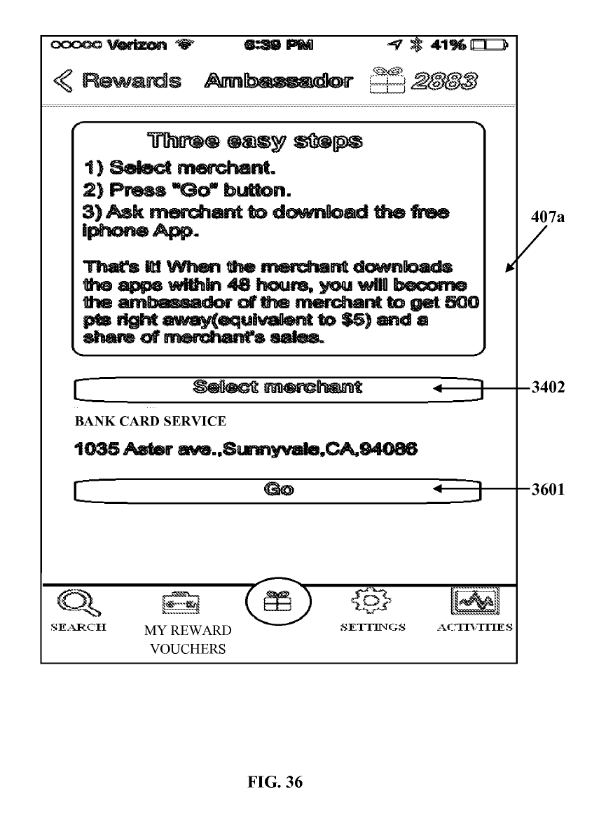

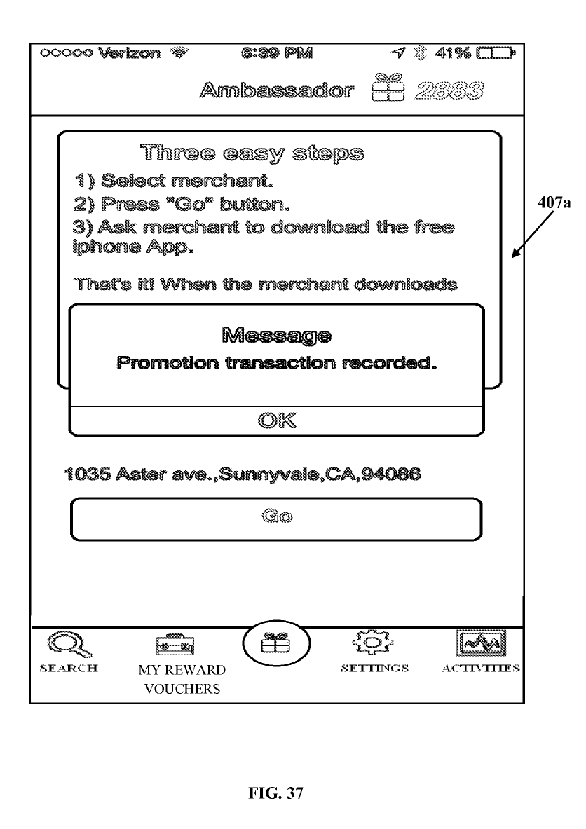

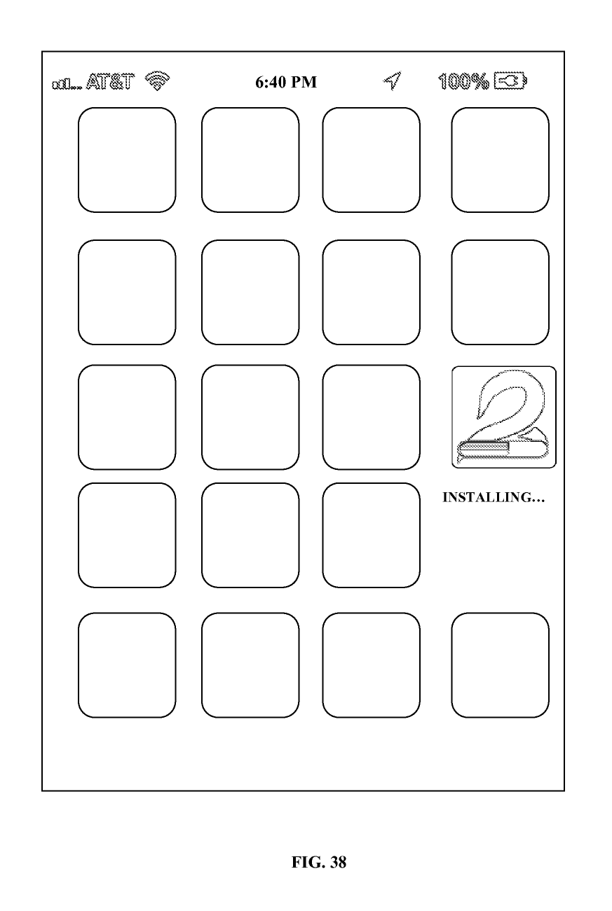

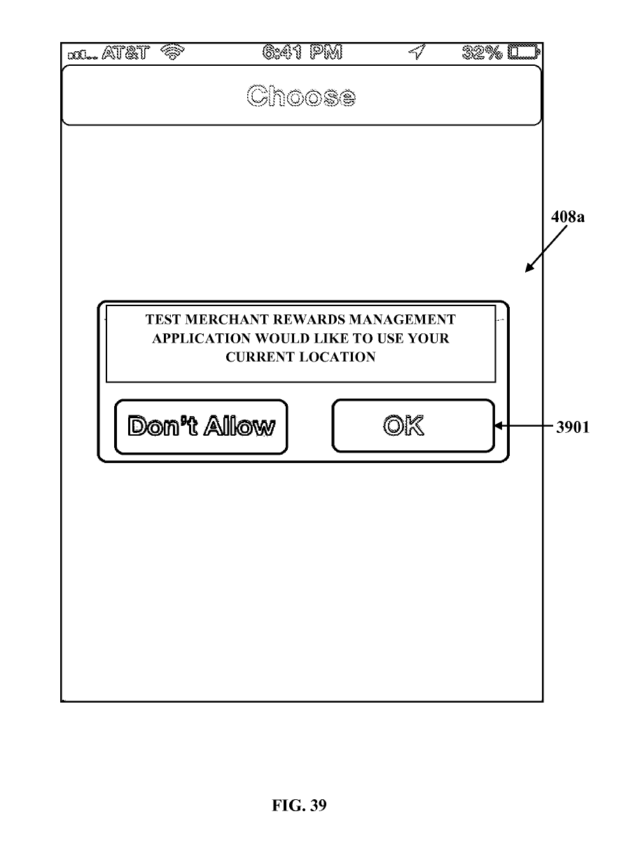

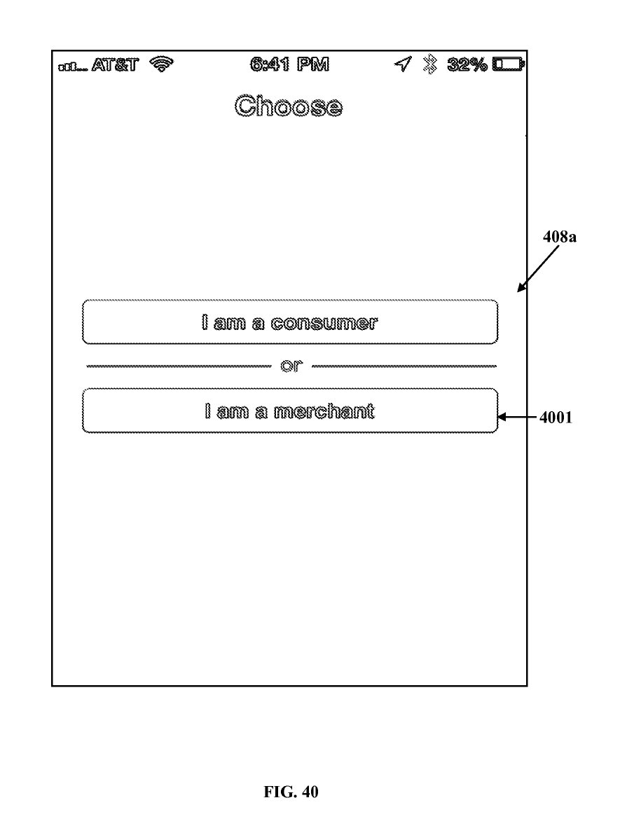

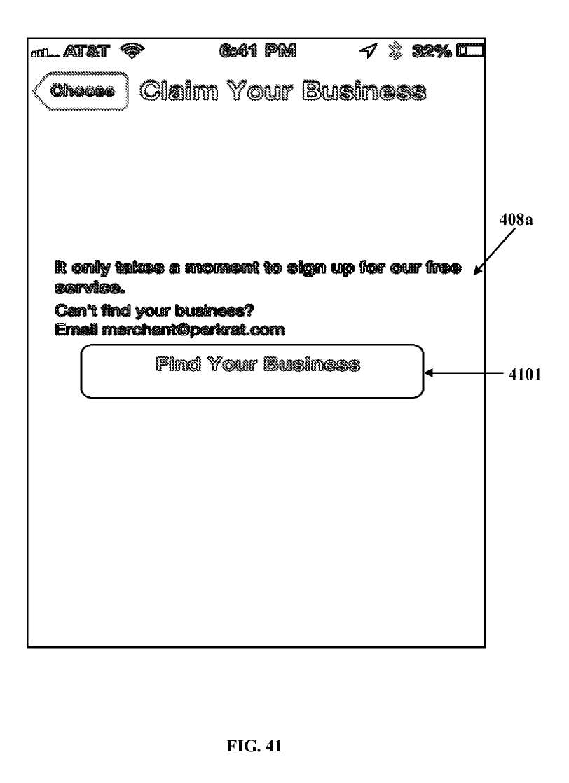

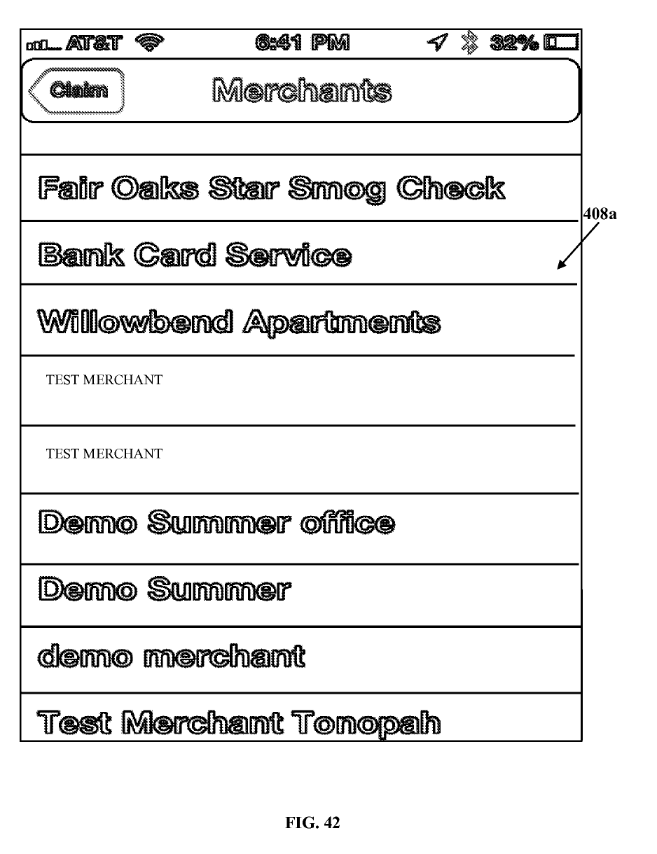

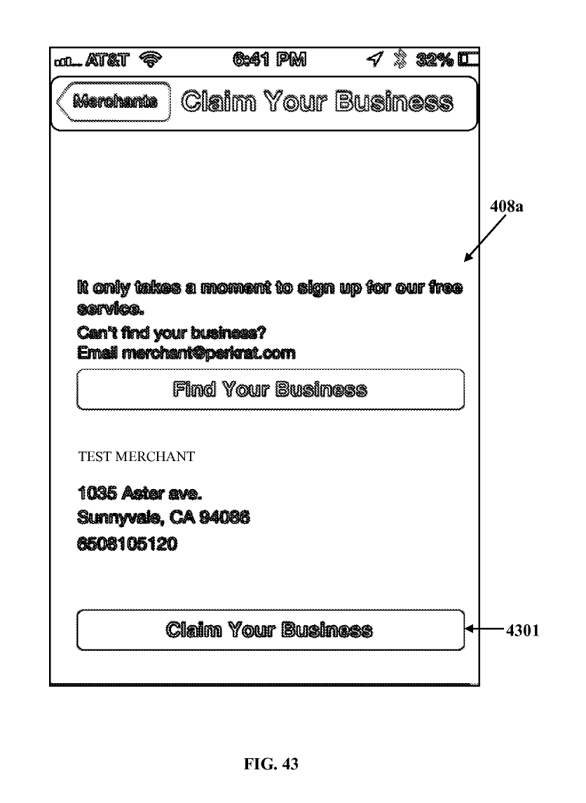

Consider another example where a consumer wants to become an ambassador of a merchant who has not joined the network of merchants participating in the universal reward points and reward vouchers management program implemented by the universal rewards management system 402 exemplarily illustrated in FIG. 4B. The universal rewards management system 402 provides an option to the consumer to become an ambassador on the GUI 407a of the consumer rewards management application 407 as exemplarily illustrated in FIG. 33. The consumer rewards management application 407 renders an instruction interface 3401 and a “Select merchant” button 3402 on the GUI 407a of the consumer rewards management application 407 as exemplarily illustrated in FIG. 34, to enable the consumer to select a merchant. The consumer may select a merchant from a list of merchants on the GUI 407a of the consumer rewards management application 407 as exemplarily illustrated in FIG. 35. The consumer clicks on the “Select merchant” button 3402 on the GUI 407a of the consumer rewards management application 407, selects, for example, Bank Card Service, from a network of merchants proximal to a current location of the consumer device 401, and clicks on a “Go” button 3601 on the GUI 407a of the consumer rewards management application 407 as exemplarily illustrated in FIG. 36. The consumer rewards management application 407 submits an authenticated request for a promotion transaction comprising, for example, a consumer ID, a merchant ID, a current time stamp, etc., to the business server 405 for performing a promotion transaction operation, for example, for saving a record of the promotion transaction. The consumer rewards management application 407 displays an acknowledgement for the promotion transaction being recorded on the GUI 407a of the consumer rewards management application 407 as exemplarily illustrated in FIG. 37. The selected merchant, for example, Bank Card Service is prompted to download the merchant rewards management application 408 on a merchant device 403. The merchant installs the merchant rewards management application 408 on the merchant device 403, and the merchant device 403 displays the installation status of the merchant rewards management application 408 on the merchant device 403 as exemplarily illustrated in FIG. 38. The merchant invokes the merchant rewards management application 408 on the merchant device 403 and clicks on an “OK” button 3901 on the GUI 408a of the merchant rewards management application 408 as exemplarily illustrated in FIG. 39, to enable the merchant rewards management application 408 to use a current location of the merchant device 403. The merchant may click on an “I am a merchant” button 4001 on the GUI 408a of the merchant rewards management application 408 as exemplarily illustrated in FIG. 40, for creating a merchant account. The merchant may then click on a “Find your business” button 4101 on the GUI 408a exemplarily illustrated in FIG. 41 to search for the merchant business, selects own name from a list of merchants on the GUI 408a exemplarily illustrated in FIG. 42 when prompted by the merchant rewards management application 408, and clicks on a “Claim your Business” button 4301 on the GUI 408a exemplarily illustrated in FIG. 43. The merchant device 403 triggers a registration code request to the business server 405.

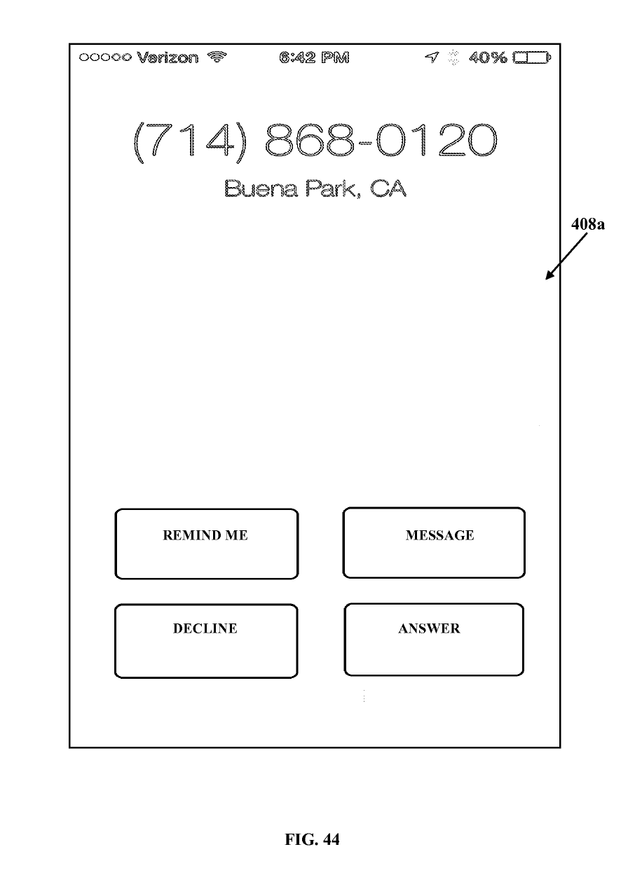

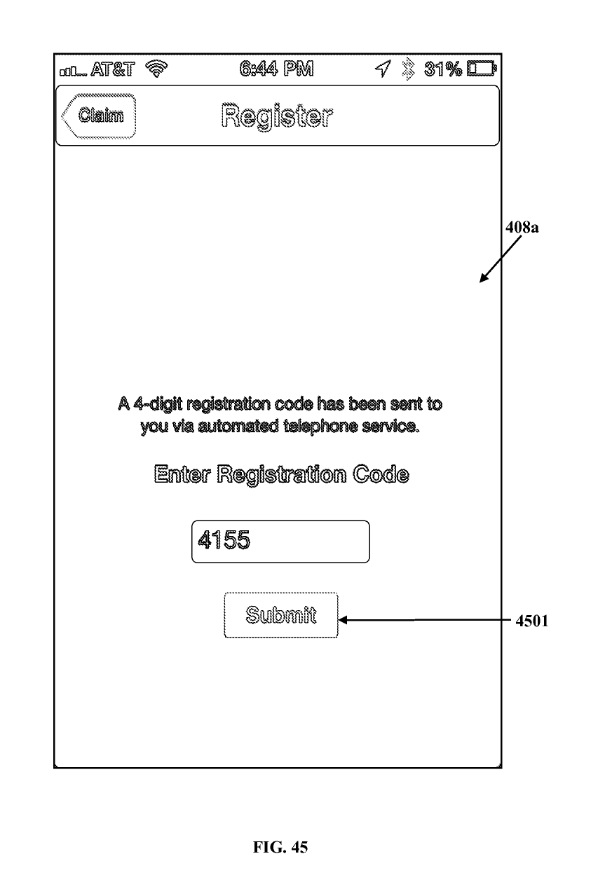

The business server 405 makes an automated voice call to a listed merchant phone number with a registration code. The merchant rewards management application 408 displays the voice call on the GUI 408a as exemplarily illustrated in FIG. 44. The merchant answers the voice call on the merchant device 403 and receives the registration code. The merchant enters the registration code on the GUI 408a of the merchant rewards management application 408 and clicks on a “submit” button 4501 on the GUI 408a exemplarily illustrated in FIG. 45. The merchant rewards management application 408 on the merchant device 403 sends a registration request comprising the registration code to the business server 405. The business server 405 validates the registration code and registers the merchant device 403 under the name of the merchant. The business server 405 marks the consumer as the ambassador of the selected merchant, when the registration of the selected merchant completes within a predetermined period of time, for example, 48 hours of the consumer selecting the merchant and submitting the promotion transaction request. In an embodiment, the universal rewards management system 402 automatically credits a percentage of universal reward points to the consumer's ambassador account for some or all future reward generation transactions with the selected merchant.

It will be readily apparent that the various methods, algorithms, and computer programs disclosed herein may be implemented on computer readable media appropriately programmed for computing devices. As used herein, “computer readable media” refers to non-transitory computer readable media that participate in providing data, for example, instructions that may be read by a computer, a processor or a similar device. Non-transitory computer readable media comprise all computer readable media, for example, non-volatile media, volatile media, and transmission media, except for a transitory, propagating signal. Non-volatile media comprise, for example, optical discs or magnetic disks and other persistent memory volatile media including a dynamic random access memory (DRAM), which typically constitutes a main memory. Volatile media comprise, for example, a register memory, a processor cache, a random access memory (RAM), etc. Transmission media comprise, for example, coaxial cables, copper wire, fiber optic cables, modems, etc., including wires that constitute a system bus coupled to a processor, etc. Common forms of computer readable media comprise, for example, a floppy disk, a flexible disk, a hard disk, magnetic tape, a laser disc, a Blu-ray Disc® of the Blu-ray Disc Association, any magnetic medium, a compact disc-read only memory (CD-ROM), a digital versatile disc (DVD), any optical medium, a flash memory card, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, or any other medium from which a computer can read.

The computer programs that implement the methods and algorithms disclosed herein may be stored and transmitted using a variety of media, for example, the computer readable media in a number of manners. In an embodiment, hard-wired circuitry or custom hardware may be used in place of, or in combination with, software instructions for implementation of the processes of various embodiments. Therefore, the embodiments are not limited to any specific combination of hardware and software. In general, the computer program codes comprising computer executable instructions may be implemented in any programming language. Some examples of programming languages that can be used comprise C, C++, C#, Java®, JavaScript®, Fortran, Ruby, Perl®, Python®, Visual Basic®, hypertext preprocessor (PHP), Microsoft® .NET etc. Other object-oriented, functional, scripting, and/or logical programming languages may also be used. The computer program codes or software programs may be stored on or in one or more mediums as object code. Various aspects of the computer implemented method and system 400 disclosed herein exemplarily illustrated in FIGS. 4A-4B, may be implemented in a non-programmed environment comprising documents created, for example, in a hypertext markup language (HTML), an extensible markup language (XML), or other format that render aspects of a graphical user interface (GUI) or perform other functions, when viewed in a visual area or a window of a browser program. Various aspects of the computer implemented method and system 400 disclosed herein may be implemented as programmed elements, or non-programmed elements, or any suitable combination thereof. The computer program product disclosed herein comprises one or more computer program codes for implementing the processes of various embodiments.

Where databases are described such as rewards management database 406 exemplarily illustrated in FIG. 4B, it will be understood by one of ordinary skill in the art that (i) alternative database structures to those described may be readily employed, and (ii) other memory structures besides databases may be readily employed. Any illustrations or descriptions of any sample databases disclosed herein are illustrative arrangements for stored representations of information. Any number of other arrangements may be employed besides those suggested by tables illustrated in the drawings or elsewhere. Similarly, any illustrated entries of the databases represent exemplary information only; one of ordinary skill in the art will understand that the number and content of the entries can be different from those disclosed herein. Further, despite any depiction of the databases as tables, other formats including relational databases, object-based models, and/or distributed databases may be used to store and manipulate the data types disclosed herein. Likewise, object methods or behaviors of a database can be used to implement various processes such as those disclosed herein. In addition, the databases may, in a known manner, be stored locally or remotely from a device that accesses data in such a database. In embodiments where there are multiple databases in the universal rewards management system 402 exemplarily illustrated in FIG. 4B, the databases may be integrated to communicate with each other for enabling simultaneous updates of data linked across the databases, when there are any updates to the data in one of the databases.

The universal rewards management system 402 can be configured to work in a network environment comprising one or more computers that are in communication with one or more devices via a network 409 exemplarily illustrated in FIG. 4B. The computers may communicate with the devices directly or indirectly, via a wired medium or a wireless medium such as the Internet, a local area network (LAN), a wide area network (WAN) or the Ethernet, a token ring, or via any appropriate communications mediums or combination of communications mediums. Each of the devices comprises processors, some examples of which are disclosed above, that are adapted to communicate with the computers. In an embodiment, each of the computers is equipped with a network communication device, for example, a network interface card, a modem, or other network connection device suitable for connecting to a network 409. Each of the computers and the devices executes an operating system, some examples of which are disclosed above. While the operating system may differ depending on the type of computer, the operating system will continue to provide the appropriate communications protocols to establish communication links with the network 409. Any number and type of machines may be in communication with the computers.

The universal rewards management system 402 is not limited to a particular computer system platform, processor, operating system, or network. One or more aspects of the universal rewards management system 402 may be distributed among one or more computer systems, for example, servers configured to provide one or more services to one or more client computers, or to perform a complete task in a distributed system. For example, one or more aspects of the universal rewards management system 402 may be performed on a client-server system that comprises components distributed among one or more server systems that perform multiple functions according to various embodiments. These components comprise, for example, executable, intermediate, or interpreted code, which communicate over a network 409 using a communication protocol. The universal rewards management system 402 is not limited to be executable on any particular system or group of systems, and is not limited to any particular distributed architecture, network, or communication protocol.

The foregoing examples have been provided merely for the purpose of explanation and are in no way to be construed as limiting of the computer implemented method and system 400 disclosed herein. While the computer implemented method and system 400 has been described with reference to various embodiments, it is understood that the words, which have been used herein, are words of description and illustration, rather than words of limitation. Further, although the computer implemented method and system 400 has been described herein with reference to particular means, materials, and embodiments, the computer implemented method and system 400 is not intended to be limited to the particulars disclosed herein; rather, the computer implemented method and system 400 extends to all functionally equivalent structures, methods and uses, such as are within the scope of the appended claims. Those skilled in the art, having the benefit of the teachings of this specification, may effect numerous modifications thereto and changes may be made without departing from the scope and spirit of the computer implemented method and system 400 in its aspects.

We claim:

1. A computer implemented method for managing collection and redemption of universal rewards, said method employing a universal rewards management system comprising at least one processor configured to execute computer program instructions for performing said method, said method comprising:
establishing a communication between a consumer device and a merchant device by said universal rewards management system based on communication criteria, on receiving a communication request from each of said consumer device and said merchant device via a network;
communicating purchase transaction information associated with a purchase made by a consumer, received from said consumer device to said merchant device by said universal rewards management system via said network, for acquiring a reward generation approval from said merchant device;
generating universal reward points for said purchase made by said consumer using said purchase transaction information and one or more of a plurality of predetermined computation parameters by said universal rewards management system based on said reward generation approval acquired from said merchant device, wherein said generated universal reward points are redeemable for any reward voucher issued by any of a plurality of merchants;
generating, by said universal rewards management system, a reward voucher redeemable from one of said merchants associated with said purchase, for a subsequent purchase made by one of said consumer and another consumer using another one or more of said predetermined computation parameters;
communicating a reward voucher redemption request for redeeming said generated reward voucher from said consumer device of said one of said consumer and said another consumer to said merchant device of said one of said merchants by said universal rewards management system via said network, for acquiring a reward voucher redemption approval from said merchant device; and
determining, by said universal rewards management system, a reduced cost for said subsequent purchase made by said one of said consumer and said another consumer based on said acquired reward voucher redemption approval to said reward voucher redemption request.

2. The computer implemented method of claim 1, further comprising:
maintaining a consumer account for said consumer by said universal rewards management system; and
crediting said generated universal reward points to said consumer account by said universal rewards management system, wherein said consumer account is accessible by said consumer device for performing one or more actions with said generated universal reward points.

3. The computer implemented method of claim 1, further comprising:
maintaining a merchant account for each of said merchants by said universal rewards management system; and
determining a redeemable reward voucher amount corresponding to said generated universal reward points using another one or more of said predetermined computation parameters, and rendering said determined redeemable reward voucher amount to said merchant account of said one of said merchants by said universal rewards management system for said generation of said reward voucher for said subsequent purchase made by said one of said consumer and said another consumer.

4. The computer implemented method of claim 1, further comprising determining balance universal reward points contained in a consumer account of said consumer using said purchase transaction information, a number of redeemed reward vouchers, and another one or more of said predetermined computation parameters.

5. The computer implemented method of claim 1, further comprising determining a number of reward vouchers issued to each of said merchants by said universal rewards management system using said purchase transaction information and another one or more of said predetermined computation parameters.

6. The computer implemented method of claim 1, further comprising transmitting a configurable amount of said generated universal reward points from a consumer account of said consumer to a consumer account of said another consumer by said universal rewards management system based on consumer sharing and exchange inputs received from said consumer device.

7. The computer implemented method of claim 1, further comprising generating supplementary universal reward points for said consumer by said universal rewards management system on registration of one or more of said merchants invited by said consumer to said universal rewards management system, wherein said supplementary universal reward points are generated by said universal rewards management system based on revenue generated by said invited one or more of said merchants.

8. The computer implemented method of claim 1, further comprising dynamically generating and rendering reward management reports to said consumer device and said merchant device by said universal rewards management system via said network, wherein said reward management reports comprise one or more of information associated with said generated universal reward points, said generated universal reward points approved by said one of said merchants, said generated reward voucher, a redemption status of said generated reward voucher, and any combination thereof.

9. The computer implemented method of claim 1, further comprising generating and rendering a list of a plurality of reward vouchers redeemable from said merchants on a graphical user interface by said universal rewards management system, for facilitating a selection of one of said reward vouchers by said one of said consumer and said another consumer for said subsequent purchase made by said one of said consumer and said another consumer, wherein said generated list of said reward vouchers is stored in a rewards management database.

10. The computer implemented method of claim 1, further comprising facilitating a search for a plurality of reward vouchers redeemable from said merchants and stored in a rewards management database by said universal rewards management system, via a graphical user interface.

11. The computer implemented method of claim 1, wherein said communication request comprises a timestamp, geographical coordinates of said each of said consumer device and said merchant device, a network address of said each of said consumer device and said merchant device, and any combination thereof.

12. The computer implemented method of claim 1, wherein said communication criteria comprise time difference between each said communication request from said each of said consumer device and said merchant device, a geographical distance between said consumer device and said merchant device, verification of a network address of said each of said consumer device and said merchant device, and any combination thereof.

13. The computer implemented method of claim 1, further comprising configuring said predetermined computation parameters by said universal rewards management system based on merchant inputs received from said merchant device of each of said merchants.

14. A universal rewards management system for managing collection and redemption of universal rewards, said universal rewards management system comprising:
a non-transitory computer readable storage medium configured to store computer program instructions defined by modules of said universal rewards management system;
at least one processor communicatively coupled to said non-transitory computer readable storage medium, said at least one processor configured to execute said defined computer program instructions; and
said modules of said universal rewards management system comprising:
a device communication module configured to establish a communication between a consumer device and a merchant device based on communication criteria, on receiving a communication request from each of said consumer device and said merchant device via a network;
a data communication module configured to communicate purchase transaction information associated with a purchase made by a consumer, received from said consumer device to said merchant device via said network, for acquiring a reward generation approval from said merchant device;
a rewards generation module configured to generate universal reward points for said purchase made by said consumer using said purchase transaction information and one or more of a plurality of predetermined computation parameters based on said reward generation approval acquired from said merchant device, wherein said generated universal reward points are redeemable for any reward voucher issued by any of a plurality of merchants;
said rewards generation module further configured to generate a reward voucher redeemable from one of said merchants associated with said purchase, for a subsequent purchase made by one of said consumer and another consumer using another one or more of said predetermined computation parameters;
said data communication module further configured to communicate a reward voucher redemption request for redeeming said generated reward voucher from said consumer device of said one of said consumer and said another consumer to said merchant device of said one of said merchants via said network, for acquiring a reward voucher redemption approval from said merchant device; and
a payment processing module configured to determine a reduced cost for said subsequent purchase made by said one of said consumer and said another consumer based on said acquired reward voucher redemption approval to said reward voucher redemption request.

15. The universal rewards management system of claim 14, wherein said rewards generation module is further configured to maintain a consumer account for said consumer and credit said generated universal reward points to said consumer account, wherein said consumer account is accessible by said consumer device for performing one or more actions with said generated universal reward points.

16. The universal rewards management system of claim 14, wherein said rewards generation module is further configured to maintain a merchant account for each of said merchants, and wherein said rewards generation module is further configured to determine a redeemable reward voucher amount corresponding to said generated universal reward points using another one or more of said predetermined computation parameters, and render said determined redeemable reward voucher amount to said merchant account of said one of said merchants for said generation of said reward voucher for said subsequent purchase made by said one of said consumer and said another consumer.

17. The universal rewards management system of claim 14, wherein said rewards generation module is further configured to determine balance universal reward points contained in a consumer account of said consumer using said purchase transaction information, a number of redeemed reward vouchers, and another one or more of said predetermined computation parameters.

18. The universal rewards management system of claim 14, wherein said rewards generation module is further configured to determine a number of reward vouchers issued to each of said merchants using said purchase transaction information and another one or more of said predetermined computation parameters.

19. The universal rewards management system of claim 14, wherein said rewards generation module is further configured to transmit a configurable amount of said generated universal reward points from a consumer account of said consumer to a consumer account of said another consumer based on consumer sharing and exchange inputs received from said consumer device.

20. The universal rewards management system of claim 14, wherein said rewards generation module is further configured to generate supplementary universal reward points for said consumer on registration of one or more of said merchants invited by said consumer to said universal rewards management system, wherein said supplementary universal reward points are generated by said rewards generation module based on revenue generated by said invited one or more of said merchants.

21. The universal rewards management system of claim 14, further comprising a report generation module configured to dynamically generate and render reward management reports to said consumer device and said merchant device via said network, wherein said reward management reports comprise one or more of information associated with said generated universal reward points, said generated universal reward points approved by said one of said merchants, said generated reward voucher, a redemption status of said generated reward voucher, and any combination thereof.

22. The universal rewards management system of claim 14, wherein said rewards generation module is further configured to generate and render a list of a plurality of reward vouchers redeemable from said merchants on a graphical user interface for facilitating a selection of one of said reward vouchers by said one of said consumer and said another consumer for said subsequent purchase made by said one of said consumer and said another consumer, wherein said generated list of said reward vouchers is stored in a rewards management database.

23. The universal rewards management system of claim 14, further comprising a search engine configured to facilitate a search for a plurality of reward vouchers redeemable from said merchants and stored in a rewards management database, via a graphical user interface.

24. The universal rewards management system of claim 14, wherein said communication request comprises a timestamp, geographical coordinates of said each of said consumer device and said merchant device, a network address of said each of said consumer device and said merchant device, and any combination thereof.

25. The universal rewards management system of claim 14, wherein said communication criteria comprise time difference between each said communication request from said each of said consumer device and said merchant device, a geographical distance between said consumer device and said merchant device, verification of a network address of said each of said consumer device and said merchant device, and any combination thereof.

26. The universal rewards management system of claim 14, wherein said rewards generation module is further configured to configure said predetermined computation parameters based on merchant inputs received from said merchant device of each of said merchants.

27. A computer program product comprising a non-transitory computer readable storage medium, said non-transitory computer readable storage medium storing computer program codes that comprise instructions executable by at least one processor, said computer program codes comprising:
a first computer program code for establishing a communication between a consumer device and a merchant device based on communication criteria, on receiving a communication request from each of said consumer device and said merchant device via a network;
a second computer program code for communicating purchase transaction information associated with a purchase made by a consumer, received from said consumer device to said merchant device via said network, for acquiring a reward generation approval from said merchant device;
a third computer program code for generating universal reward points for said purchase made by said consumer using said purchase transaction information and one or more of a plurality of predetermined computation parameters based on said reward generation approval acquired from said merchant device, wherein said generated universal reward points are redeemable for any reward voucher issued by any of a plurality of merchants;
a fourth computer program code for generating a reward voucher redeemable from one of said merchants associated with said purchase, for a subsequent purchase made by one of said consumer and another consumer using another one or more of said predetermined computation parameters;
a fifth computer program code for communicating a reward voucher redemption request for redeeming said generated reward voucher from said consumer device of said one of said consumer and said another consumer to said merchant device of said one of said merchants via said network, for acquiring a reward voucher redemption approval from said merchant device; and
a sixth computer program code for determining a reduced cost for said subsequent purchase made by said one of said consumer and said another consumer based on said acquired reward voucher redemption approval to said reward voucher redemption request.
